(19) United States
(12) Patent Application Publication
(10) Pub. No.: US 2012/0287043 A1
(43) Pub. Date: Nov. 15, 2012

(54) COMPUTER-READABLE STORAGE MEDIUM HAVING MUSIC PERFORMANCE PROGRAM STORED THEREIN, MUSIC PERFORMANCE APPARATUS, MUSIC PERFORMANCE SYSTEM, AND MUSIC PERFORMANCE METHOD

(75) Inventors: Yoichi YAMADA, Kyoto (JP); Hidemaro Fujibayashi, Kyoto (JP); Hajime Wakai, Kyoto (JP); Masato Mizuta, Kyoto (JP); Hiroshi Umemiya, Kyoto (JP)

(73) Assignee: NINTENDO CO., LTD., Kyoto (JP)

(21) Appl. No.: 13/205,145

(22) Filed: Aug. 8, 2011

(30) Foreign Application Priority Data
May 11, 2011 (JP) 2011-106553

(51) Int. Cl. G06F 3/033

(52) U.S. Cl. 345/158

(57) ABSTRACT

An input device includes a movement and orientation sensor for detecting one of a movement or an orientation of the input device itself. Firstly, information about one of the movement or the orientation of the input device having been detected by this movement and orientation sensor is obtained. Next, a difference between the orientation of the input device having been obtained, and a predetermined reference orientation is calculated. A predetermined sound is produced based on the difference in orientation, thereby executing music performance.

### CROSS REFERENCE TO RELATED APPLICATION

The disclosure of Japanese Patent Application No. 2011-106553, filed on May 11, 2011, is incorporated herein by reference.

### BACKGROUND OF THE INVENTION

1. Field of the Invention

The present invention relates to a computer-readable storage medium having a music performance program stored therein, a music performance apparatus, a music performance system, and a music performance method, and more particularly to a computer-readable storage medium having stored therein a music performance program, a music performance apparatus, a music performance system, and a music performance method for executing music performance based on a movement of an input device.

2. Description of the Background Art

Technology for virtually executing music performance based on a movement of an input device has been known to date (for example, page 10 to page 11 of the instruction manual for Wii software “Wii Music”, released by Nintendo Co., Ltd. on Oct. 16, 2008). In this technology, moving (shaking) the input device once in a predetermined direction is handled as an action for one stroke in the case of a guitar, and as an operation for one hit (operation for one beating) in the case of a percussion instrument, thereby executing virtual performance of a musical instrument.

In the technology as described above, when the input device is moved in a predetermined direction, music performance for one stroke is executed in the case of a guitar, and music performance for one hit is executed in the case of a percussion instrument. Namely, detection of movement of the input device in the predetermined direction is used for determining a time at which the music performance (operation) for one stroke of a guitar is started, or a time at which the music performance (operation) for hitting a percussion instrument once is started. This is not substantially different from a manner in which a time at which the above-described operation is started is determined based on detection of an input using a button, and minute music performance operation based on variable movement cannot be executed.

### SUMMARY OF THE INVENTION

Therefore, an object of the present invention is to make available a computer-readable storage medium having stored therein a music performance program capable of executing music performance operation with enhanced minuteness, by an operation of moving an input device itself, and the like.

In order to attain the aforementioned object, the present invention has the following features.

A computer-readable storage medium having stored therein a music performance program according to one aspect of the present invention is directed to a computer-readable storage medium having stored therein a music performance program executed by a computer of a music performance apparatus for executing music performance based on an input from an input device having a movement and orientation sensor for detecting one of a movement and an orientation of the input device itself, and the computer is caused to function as: movement and orientation information obtaining means; orientation difference calculation means; and music performance means. The movement and orientation information obtaining means obtains information about one of a movement and an orientation of the input device, the one of the movement and the orientation of the input device being detected by the movement and orientation sensor. The orientation difference calculation means calculates a difference between a predetermined reference orientation, and the orientation of the input device having been obtained by the movement and orientation information obtaining means. The music performance means executes music performance by producing a predetermined sound based on the difference in orientation calculated by the orientation difference calculation means.

In the configuration described above, various music performance operations are enabled with enhanced minuteness.

In another exemplary configuration, the music performance program may cause the computer to further function as reference orientation setting means for setting, to the predetermined reference orientation, an orientation of the input device obtained at a predetermined time. The orientation difference calculation means may calculate the difference between the predetermined reference orientation and the orientation of the input device having been obtained by the movement and orientation information obtaining means, after the predetermined reference orientation has been set.

In the exemplary configuration described above, for example, an orientation of the input device obtained at a time when a certain button is pressed is used as the reference orientation, and thus music performance operation can be executed, thereby enabling enhancement of operability for the music performance operation.

In still another exemplary configuration, the music performance means may produce, when the difference in orientation having been calculated by the orientation difference calculation means exceeds a predetermined threshold value which is predefined for the difference in orientation, a sound according to the predetermined threshold value.

In still another exemplary configuration, the number of the predetermined threshold values to be set may be greater than one.

In the exemplary configuration described above, music performance operation is enabled with enhanced minuteness.

In still another exemplary configuration, the music performance program may cause the computer to further function as change amount detection means for detecting an amount of change of one of the movement and the orientation of the input device per unit time, the one of the movement and the orientation of the input device having been obtained by the movement and orientation information obtaining means. The music performance means may change the predetermined threshold value according to the amount of change of one of the movement and the orientation.

In the exemplary configuration described above, sound produced when the input device is in a certain orientation can be changed according to an amount of change of movement of the input device, such as, a speed at which the input device is shaken. Thus, for example, when the virtual stringed instrument is played, a process for changing the distance between strings of the stringed instrument according to an amount of change of the movement of the input device can be performed. As a result, the same number of strings may be plunked so as to produce the same number of sounds regardless of whether the input device is shaken fast or slowly (for example, in order to plunk the twelve strings for producing sounds of the twelve strings, in both a case where the input device is being shaken slowly, and a moving distance of the input device itself is relatively great, and a case where the input device is being shaken fast, and a moving distance of the input device is small, all the twelve strings can be plunked to produce sounds of the twelve strings).

In still another exemplary configuration, the music performance means may change the predetermined threshold value such that the greater the amount of change of one of the movement and the orientation is, the less the predetermined threshold value is.

In the exemplary configuration described above, for example, in a case where the virtual stringed instrument is played, the number of strings which can be plunked can be the same between when the input device is shaken fast and when the input device is shaken slowly.

In still another exemplary configuration, the music performance program may cause the computer to further function as change amount calculation means for calculating an amount of change of one of the movement and the orientation of the input device per unit time, the one of the movement and the orientation of the input device having been obtained by the movement and orientation information obtaining means. The music performance means may change a correspondence relationship between the difference calculated by the orientation difference calculation means, and a sound to be produced based on the difference, according to the amount of change of one of the movement and the orientation having been calculated.

In the exemplary configuration described above, sound which is produced when the input device is positioned at a certain position (orientation) can be changed according to a magnitude (for example, shaking speed) of the movement of the input device. Thus, for example, the type of sound to be produced can be changed between when the input device is shaken fast and when the input device is shaken slowly. Therefore, various music performance operations can be performed, thereby enabling the music performance operation to be diversified.

In still another exemplary configuration, the music performance program may cause the computer to further function as change amount determination means for determining, after the predetermined reference orientation is set by the reference orientation setting means, whether an amount of change of one of the movement and the orientation of the input device per unit time is greater than or equal to a predetermined amount, the one of the movement and the orientation of the input device having been obtained by the movement and orientation information obtaining means. The music performance means may start music performance at a time point when the change amount determination means determines that the amount of change of one of the movement and the orientation of the input device is greater than or equal to the predetermined amount.

In the exemplary configuration described above, for example, production of sound in response to a minute movement of a hand, such as jiggling of a hand, can be prevented, thereby enabling operability for the music performance operation to be enhanced.

In still another exemplary configuration, the input device may further include a predetermined input section. The music performance program may cause the computer to further function as input determination means for determining whether an input has been performed on the predetermined input section. The reference orientation setting means may set, to the predetermined reference orientation, an orientation obtained when the input determination means determines that an input has been performed on the predetermined input section.

In the exemplary configuration described above, the music performance operation can be executed based on the orientation of the input device obtained at any time, thereby enabling enhancement of the operability.

In still another exemplary configuration, the input device may further include a predetermined input section. The music performance program may cause the computer to further function as input determination means for determining whether an input has been performed on the predetermined input section. The music performance means may execute music performance only when the input determination means determines that an input is performed on the predetermined input section.

In the exemplary configuration described above, for example, only when a player is pressing a predetermined button on the input device, sound can be outputted, thereby enabling operability for music performance operation to be enhanced.

In still another exemplary configuration, the orientation difference calculation means may calculate an amount of rotation of the input device about a predetermined axis of the input device relative to the predetermined reference orientation, as the difference between the predetermined reference orientation, and the orientation of the input device having been obtained by the movement and orientation information obtaining means.

In the exemplary configuration described above, for example, the change of the orientation of the input device can be detected with enhanced accuracy by using the angular velocity data, thereby enabling minute music performance.

In still another exemplary configuration, the orientation difference calculation means may calculate the difference from the predetermined reference orientation, based on an amount of rotation of the input device about the predetermined axis of the input device, and an amount of rotation of the input device about an axis orthogonal to the predetermined axis.

In the exemplary configuration described above, for example, change of the orientation of the input device which is caused due to a wrist being twisted in an operation for shaking the input device can be taken into consideration, for calculating the difference from the reference orientation.

In still another exemplary configuration, the predetermined axis may be an axis for determining a direction in which the input device is shaken.

In the exemplary configuration described above, sound can be produced according to a direction in which the input device is shaken.

In still another exemplary configuration, the orientation difference calculation means may transform an amount of rotation of the input device about an axis different from the predetermined axis, into an amount of rotation of the input device about the predetermined axis, and calculate the difference based on the amount of rotation about the predetermined axis and the amount of rotation obtained through the transformation.

In the exemplary configuration described above, for example, change of the orientation of the input device which is caused due to a wrist being twisted in an operation for shaking the input device can be taken into consideration, for calculating the difference from the reference orientation.

In still another exemplary configuration, each of the movement and orientation information obtaining means, the orientation difference calculation means, and the music performance means may repeat a process loop. The predetermined reference orientation may be an orientation based on the information about one of the movement and the orientation of the input device which has been obtained by the movement and orientation information obtaining means in an immediately preceding process loop.

In still another exemplary configuration, the music performance means may include difference accumulation means for calculating an accumulation of each difference in orientation calculated by the orientation difference calculation means, and the music performance means may execute music performance based on the accumulation of each difference in orientation calculated by the difference accumulation means.

In the exemplary configuration described above, sound can be produced according to the orientation of the input device, thereby enabling minute music performance operation.

In still another exemplary configuration, the movement and orientation sensor may be an acceleration sensor and/or an angular velocity sensor.

In the exemplary configuration described above, a movement or an orientation of the input device can be detected with enhanced ease and accuracy.

A music performance apparatus according to another aspect of the present invention is directed to a music performance apparatus for executing music performance based on an input from an input device having a movement and orientation sensor for detecting one of a movement and an orientation of the input device itself, and the music performance apparatus includes: movement and orientation information obtaining means; orientation difference calculation means; and music performance means. The movement and orientation information obtaining means obtains information about one of a movement and an orientation of the input device, the one of the movement and the orientation of the input device being detected by the movement and orientation sensor. The orientation difference calculation means calculates a difference between a predetermined reference orientation, and the orientation of the input device having been obtained by the movement and orientation information obtaining means. The music performance means executes music performance by producing a predetermined sound based on the difference in orientation calculated by the orientation difference calculation means.

A music performance system according to another aspect of the present invention is directed to a music performance system for executing music performance based on an input from an input device having a movement and orientation sensor for detecting one of a movement and an orientation of the input device itself, and the music performance system includes: movement and orientation information obtaining means; orientation difference calculation means; and music performance means. The movement and orientation information obtaining means obtains information about one of a movement and an orientation of the input device, the one of the movement and the orientation of the input device being detected by the movement and orientation sensor. The orientation difference calculation means calculates a difference between a predetermined reference orientation, and the orientation of the input device having been obtained by the movement and orientation information obtaining means. The music performance means executes music performance by producing a predetermined sound based on the difference in orientation calculated by the orientation difference calculation means.

A music performance method according to another aspect of the present invention is directed to a music performance method used by a music performance apparatus for executing music performance based on an input from an input device having a movement and orientation sensor for detecting one of a movement and an orientation of the input device itself, and the music performance method includes: a movement and orientation information obtaining step; an orientation difference calculation step; and a music performance step. The movement and orientation information obtaining step obtains information about one of a movement and an orientation of the input device, the one of the movement and the orientation of the input device being detected by the movement and orientation sensor. The orientation difference calculation step calculates a difference between a predetermined reference orientation, and the orientation of the input device having been obtained by the movement and orientation information obtaining step. The music performance step executes music performance by producing a predetermined sound based on the difference in orientation calculated by the orientation difference calculation step.

According to the aspects of the present invention, various sounds can be produced according to a movement or an orientation of the input device itself, thereby enabling music performance operation with enhanced minuteness.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating an outer appearance of a game system 1;

FIG. 2 is a block diagram illustrating a configuration of a game apparatus 3;

FIG. 3 is a perspective view of an outer structure of an input device 8;

FIG. 4 is a perspective view of an outer structure of a controller 5;

FIG. 5 is a diagram illustrating an internal configuration of the controller 5;

FIG. 6 is a diagram illustrating an internal configuration of the controller 5;

FIG. 7 is a block diagram illustrating a configuration of the input device 8;

FIG. 8 shows an exemplary game image;

FIG. 9A is a diagram illustrating a correspondence relationship between an orientation of the input device 8 and each string of a harp 102;

FIG. 9B is a diagram illustrating a correspondence relationship between an orientation of the input device 8 and each string of a harp 102;

FIG. 10 illustrates an exemplary manner in which the input device is moved;

FIG. 11 illustrates another exemplary manner in which the input device is moved;

FIG. 12 is a diagram illustrating main data to be stored in a main memory of the game apparatus 3;

FIG. 13 is a flow chart showing in detail the entirety of a game process;

FIG. 14 is a flow chart showing in detail a harp mode process of step S4;

FIG. 15 is a flow chart showing in detail an angular velocity calculation process of step S15;

FIG. 16 is a flow chart showing in detail a sound output process of step S18;

FIG. 17 is a diagram illustrating a threshold value for producing sound of the immediately following string;

FIG. 18 is a flow chart showing an angular velocity calculation process according to another embodiment;

FIG. 19A is a diagram illustrating change of the threshold value for producing sound of the immediately following string;

FIG. 19B is a diagram illustrating change of the threshold value for producing sound of the immediately following string;

FIG. 20 is a diagram illustrating a relationship between a magnitude of a movement of the input device, and change of the threshold value;

FIG. 21 is a diagram illustrating a relationship between a magnitude of a movement of the input device, and change of the threshold value; and

FIG. 22 is a diagram illustrating another exemplary initial position.

### DESCRIPTION OF THE PREFERRED EMBODIMENTS

Hereinafter, embodiments of the present invention will be described with reference to the drawings. It is to be noted that the present invention is not limited to the embodiments described below.

The present invention is directed to technology for outputting a predetermined sound by moving an input device itself. As will be described below in detail, an orientation of the input device at a predetermined time point is defined as a reference orientation, and a plurality of sounds in a sound row are selectively used and outputted according to a difference between the reference orientation and an orientation of the input device which is determined after the predetermined time point. Namely, the present invention represents technology for outputting a sound based on the difference.

[Overall Configuration of Game System]

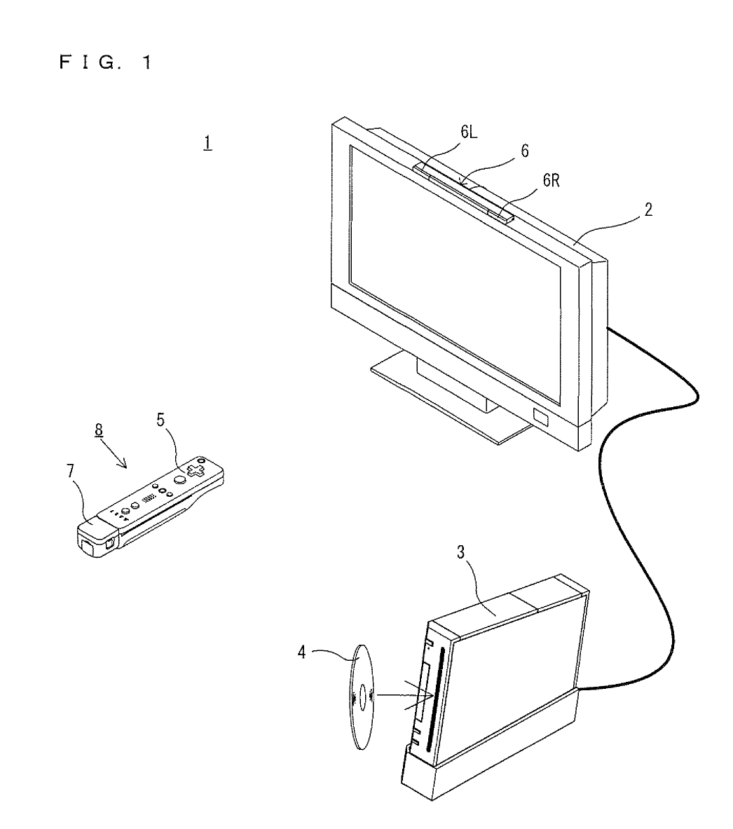

A game system 1 including a game apparatus typifying an information processing apparatus according to an embodiment of the present invention will be described with reference to FIG. 1. FIG. 1 is a diagram illustrating an outer appearance of the game system 1. Hereinafter, the game apparatus and a game program of the present embodiment will be described by using a stationary game apparatus as an example. As shown in FIG. 1, the game system 1 includes a television receiver (hereinafter, referred to simply as “television”) 2, a game apparatus 3, an optical disc 4, an input device 8, and a marker section 6. In the system of the present embodiment, a game process is executed by the game apparatus 3 based on a game operation using the input device 8.

The optical disc 4, which is an exemplary exchangeable information storage medium used for the game apparatus 3, is detachably inserted in the game apparatus 3. A game program which is executed by the game apparatus 3 is stored in the optical disc 4. An insertion opening through which the optical disc 4 is inserted is provided on the front surface of the game apparatus 3. The game apparatus 3 reads and executes the game program stored in the optical disc 4 that has been inserted through the insertion opening, thereby executing the game process

The game apparatus 3 is connected to the television 2, which is an exemplary display device, via a connecting cord. The television 2 displays a game image obtained as a result of the game process executed by the game apparatus 3. The marker section 6 is provided in the vicinity of the screen of the television 2 (in FIG. 1, in a portion above the screen). The marker section 6 includes two markers 6R and 6L at both ends thereof. Specifically, the marker 6R (and the marker 6L) is implemented as at least one infrared LED, and outputs infrared light forward of the television 2. The marker section 6 is connected to the game apparatus 3, and the game apparatus 3 is able to control whether each infrared LED of the marker section 6 is to be lit up.

The input device 8 provides the game apparatus 3 with operation data representing contents of an operation performed on the input device 8 itself. In the present embodiment, the input device 8 includes a controller 5 and a gyro sensor unit 7. As will be described below in detail, the input device 8 is configured such that the gyro sensor unit 7 is detachably connected to the controller 5. The controller 5 and the game apparatus 3 are connected to each other by wireless communication. In the present embodiment, for example, technology such as Bluetooth (registered trademark) is used for the wireless communication between the controller 5 and the game apparatus 3. It is to be noted that, in another embodiment, the controller 5 and the game apparatus 3 may be wire-connected.

[Internal Configuration of Game Apparatus 3]

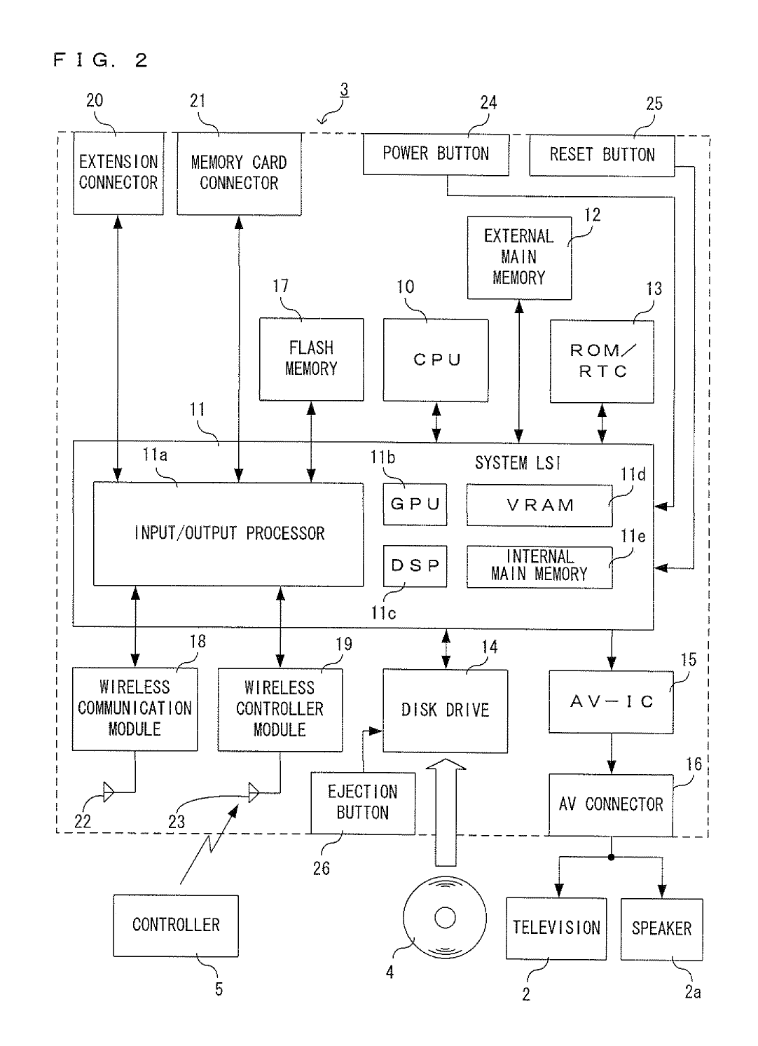

Next, with reference to FIG. 2, the internal configuration of the game apparatus 3 will be described. FIG. 2 is a block diagram illustrating a configuration of the game apparatus 3. The game apparatus 3 includes a CPU 10, a system LSI 11, an external main memory 12, a ROM/RTC 13, a disk drive 14, an AV-IC 15, and the like.

The CPU 10 executes the game process by executing the game program stored in the optical disc 4, and functions as a game processor. The CPU 10 is connected to the system LSI 11. In addition to the CPU 10, the external main memory 12, the ROM/RTC 13, the disk drive 14, and the AV-IC 15 are connected to the system LSI 11. The system LSI 11 performs processes such as control of data transfer among each component connected to the system LSI 11, generation of images to be displayed, and acquisition of data from external devices. The internal configuration of the system LSI 11 will be described below. The external main memory 12, which is a volatile memory, stores programs such as a game program loaded from the optical disc 4, and a game program loaded from a flash memory 17, and various data. The external main memory 12 is used as a work area and a buffer area for the CPU 10. The ROM/RTC 13 includes a ROM (so-called boot ROM) having incorporated therein a program for starting up the game apparatus 3, and a clock circuit (RTC: Real Time Clock) for counting time. The disk drive 14 reads program data, texture data, and the like from the optical disc 4, and writes the read data in the external main memory 12 or an internal main memory 11e which will be described below.

Furthermore, the system LSI 11 is provided with an input/output processor (I/O processor) 11a, a GPU (Graphics Processor Unit) 11b, a DSP (Digital Signal Processor) 11e, a VRAM 11d, and the internal main memory 11e. Although not shown, these components 11a to 11e are connected to each other via an internal bus.

The GPU 11b, which is a portion of rendering means, generates an image according to a graphics command (rendering instruction) from the CPU 10. The VRAM 11d stores data (data such as polygon data and texture data) necessary for the GPU 11b to execute the graphics command. When an image is to be generated, the GPU 11b generates image data by using the data stored in the VRAM 11d.

The DSP 11e functions as an audio processor, and generates audio data by using sound data and sound waveform (tone) data stored in the internal main memory 11e and the external main memory 12.

The image data and audio data having been thus generated are read by the AV-IC 15. The AV-IC 15 outputs the read image data to the television 2 via an AV connector 16, and outputs the read audio data to a loudspeaker 2a built in the television 2. Thus, an image is displayed on the television 2 and sound is outputted from the loudspeaker 2a.

The input/output processor 11a performs data transmission to and data reception from components connected thereto, and downloads data from an external device. The input/output processor 11a is connected to the flash memory 17, a wireless communication module 18, a wireless controller module 19, an extension connector 20, and a memory card connector 21. The wireless communication module 18 is connected to an antenna 22, and the wireless controller module 19 is connected to an antenna 23.

The input/output processor 11a is connected to a network via the wireless communication module 18 and the antenna 22, and is capable of communicating with other game apparatuses and various servers connected to the network. The input/output processor 11a periodically accesses the flash memory 17 to detect for presence or absence of data to be transmitted to the network. If there is data to be transmitted, the input/output processor 11a transmits the data to the network through the wireless communication module 18 and the antenna 22. The input/output processor 11a receives data transmitted from the other game apparatuses or data downloaded from a download server, via the network, the antenna 22, and the wireless communication module 18, and stores the received data in the flash memory 17. The CPU 10 reads the data stored in the flash memory 17 and uses the read data in the game program by executing the game program. In the flash memory 17, in addition to data to be transmitted from the game apparatus 3 to the other game apparatuses and the various servers, and data received by the game apparatus 3 from the other game apparatuses and the various servers, saved data (game result data or game progress data) of a game played by using the game apparatus 3 may be stored.

Further, the input/output processor 11a receives operation data transmitted from the controller 5 via the antenna 23 and the wireless controller module 19, and (temporarily) stores the operation data in the buffer area of the internal main memory 11e or the external main memory 12.

Further, the extension connector 20 and the memory card connector 21 are connected to the input/output processor 11a. The extension connector 20 is a connector for an interface such as a USB and an SCSI. The extension connector 20 enables connection to a medium such as an external storage medium, and connection to a peripheral device such as another controller. Further, the extension connector 20 enables the game apparatus 3 to communicate with a network without using the wireless communication module 18, when connected to a connector for wired communication. The memory card connector 21 is a connector for connecting to an external storage medium such as a memory card. For example, the input/output processor 11a accesses the external storage medium via the extension connector 20 or the memory card connector 21, and can store data in the external storage medium or read data from the external storage medium.

The game apparatus 3 is provided with a power button 24, a reset button 25, and an ejection button 26. The power button 24 and the reset button 25 are connected to the system LSI 11. When the power button 24 is on, power is supplied to each component of the game apparatus 3 via an AC adaptor which is not shown. When the reset button 25 is pressed, the system LSI 11 restarts the boot program of the game apparatus 3. The ejection button 26 is connected to the disk drive 14. When the ejection button 26 is pressed, the optical disc 4 is ejected from the disk drive 14.

[Configuration of Input Device 8]

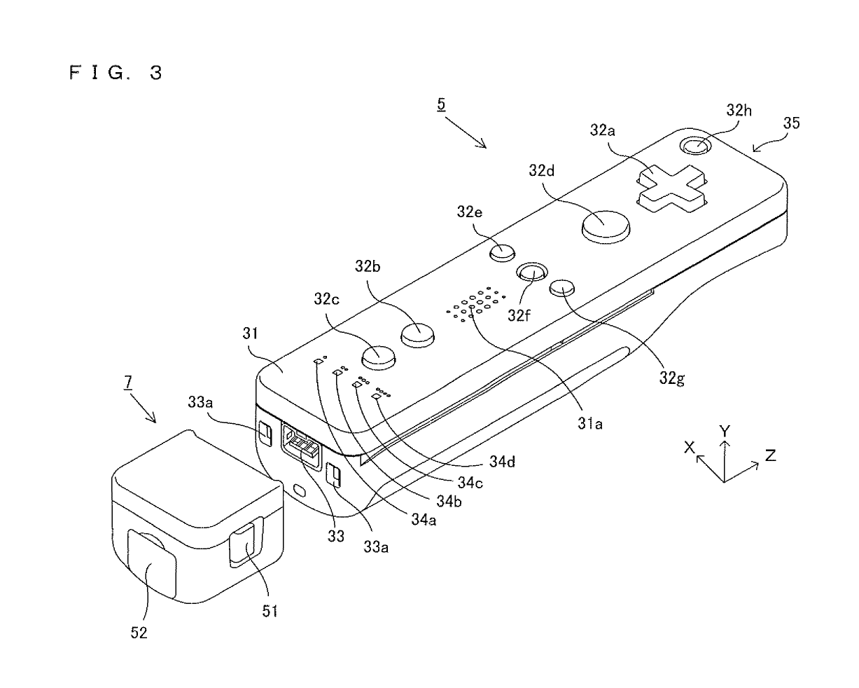

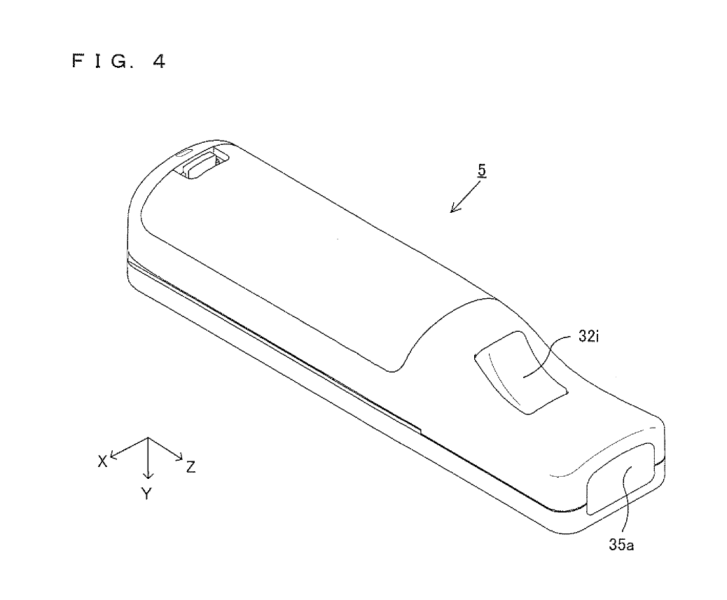

Next, the input device 8 will be described with reference to FIG. 3 to FIG. 6. FIG. 3 is a perspective view of an outer structure of the input device 8. FIG. 4 is a perspective view of an outer structure of the controller 5. FIG. 3 is a perspective view of the controller 5 as viewed from the top rear side thereof. FIG. 4 is a perspective view of the controller 5 as viewed from the bottom front side thereof.

As shown in FIG. 3 and FIG. 4, the controller 5 includes a housing 31 formed by, for example, plastic molding. The housing 31 is generally shaped in a rectangular parallelepiped extending in a longitudinal direction which corresponds to the front-rear direction (Z-axis direction in FIG. 3). The overall size of the housing 31 is small enough to be held by one hand of an adult or even a child. A player is allowed to perform a game operation by pressing buttons on the controller 5, and moving the controller 5 itself to change the position and the orientation of the controller 5.

The housing 31 is provided with a plurality of operation buttons. As shown in FIG. 3, on the top surface of the housing 31, a cross button 32a, a first button 32b, a second button 32c, an A button 32d, a minus button 32e, a home button 32f, a plus button 32g, and a power button 32h are provided. In the present embodiment, the top surface of the housing 31 on which these buttons 32a to 32h are provided may be referred to as a “button surface”. On the other hand, as shown in FIG. 4, a recessed portion is formed on the bottom surface of the housing 31. A B button 32i is formed on a sloped surface of the rear portion of the recessed portion. These operation buttons 32a to 32i are assigned functions, respectively, based on the game program executed by the game apparatus 3 as necessary. Further, the power button 32h is used for remotely powering on or off the game apparatus 3 body. The home button 32f and the power button 32h each have a top surface thereof buried in the top surface of the housing 31, so as not to be inadvertently pressed by the player.

On the rear surface of the housing 31, a connector 33 is provided. The connector 33 is used for connecting another device (for example, the gyro sensor unit 7 or another controller) to the controller 5. Further, engagement holes 33a for preventing disconnection of the other device from being unnecessarily facilitated are provided to the right and the left of the connector 33 on the rear surface of the housing 31.

A plurality (four in FIG. 3) of LEDs 34a to 34d are provided on the rear portion on the top surface of the housing 31. The controller 5 is assigned a controller type (number) so as to be distinguishable from the other main controllers. The LEDs 34a to 34d are used for, for example, informing a player of the controller type which is currently set to controller 5 that the player is using, and informing the player of remaining battery power of the controller 5. Specifically, when the game operation is performed by using the controller 5, one of the plurality of LEDs 34a to 34d is lit up according to the controller type.

The controller 5 has an imaging information calculation section 35 (FIG. 6), and has a light incident surface 35a of the imaging information calculation section 35 on the front surface of the housing 31 as shown in FIG. 4. The light incident surface 35a is formed of a material which transmits at least infrared light from the markers 6R and 6L.

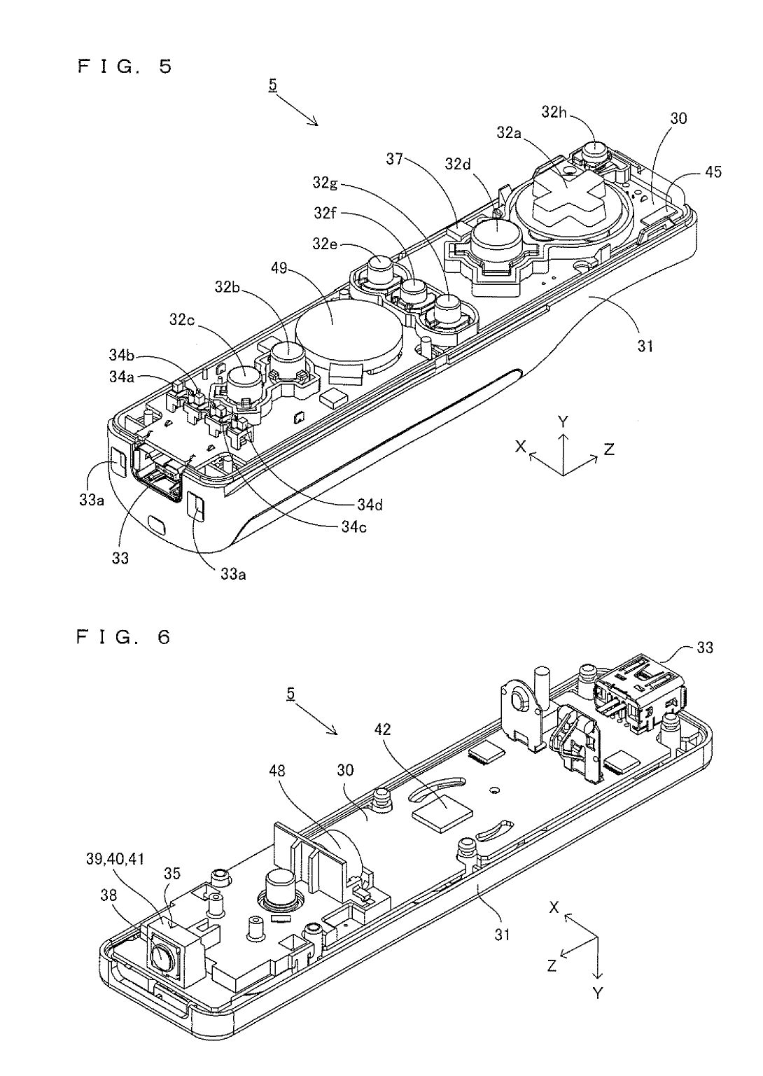

A sound hole 31a for outputting sound from the speaker 49 (FIG. 5) incorporated in the controller 5 is formed between the first button 32b and the home button 32f on the top surface of the housing 31.

Next, an internal configuration of the controller 5 will be described with reference to FIG. 5 and FIG. 6. FIG. 5 and FIG. 6 are diagrams illustrating the internal configuration of the controller 5. FIG. 5 is a perspective view illustrating a state in which an upper casing (a portion of the housing 31) of the controller 5 is removed. FIG. 6 is a perspective view illustrating a state in which a lower casing (a portion of the housing 31) of the controller 5 is removed. FIG. 6 is a perspective view illustrating a reverse side of a substrate 30 shown in FIG. 5.

As shown in FIG. 5, the substrate 30 is fixed inside the housing 31. On the top main surface of the substrate 30, the operation buttons 32a to 32h, the LEDs 34a to 34d, an acceleration sensor 37, an antenna 45, the speaker 49, and the like are provided. These elements are connected to a microcomputer 42 (see FIG. 6) via lines (not shown) formed on the substrate 30 and the like. In the present embodiment, the acceleration sensor 37 is positioned so as to be deviated from the center of the controller 5 in the X-axis direction. Thus, calculation of the movement of the controller 5 can be facilitated when the controller 5 is rotated around the Z axis. Further, the acceleration sensor 37 is positioned in front of the longitudinal (Z-axis direction) center of the controller 5. Further, a wireless module 44 and the antenna 45 enable the controller 5 to functions as a wireless controller.

At the front edge on the bottom main surface of the substrate 30, the imaging information calculation section 35 is provided as shown in FIG. 6. The imaging information calculation section 35 includes an infrared filter 38, a lens 39, an image pickup element 40, and an image processing circuit 41 located in order, respectively, from the front surface of the controller 5 on the bottom main surface of the substrate 30.

On the bottom main surface of the substrate 30, the microcomputer 42 and a vibrator 48 are provided. The vibrator 48 may be, for example, a vibration motor or a solenoid. The vibrator 48 is connected to the microcomputer 42 by lines formed on the substrate 30 and the like. The controller 5 is vibrated by an actuation of the vibrator 48 according to an instruction from the microcomputer 42. Therefore, the vibration is conveyed to the player's hand holding the controller 5. Thus, a so-called vibration-feedback game is realized. In the present embodiment, the vibrator 48 is positioned slightly in front of the longitudinal center of the housing 31. Namely, the vibrator 48 is positioned at the end portion of the controller 5 so as to be deviated from the center of the controller 5, so that the vibration of the vibrator 48 can increase the vibration of the entirety of the controller 5. The connector 33 is mounted to the rear edge on the bottom main surface of the substrate 30. The controller 5 includes, in addition to the components shown in FIG. 5 and FIG. 6, a quartz oscillator for generating a reference clock of the microcomputer 42, an amplifier for outputting a sound signal to the speaker 49, and the like.

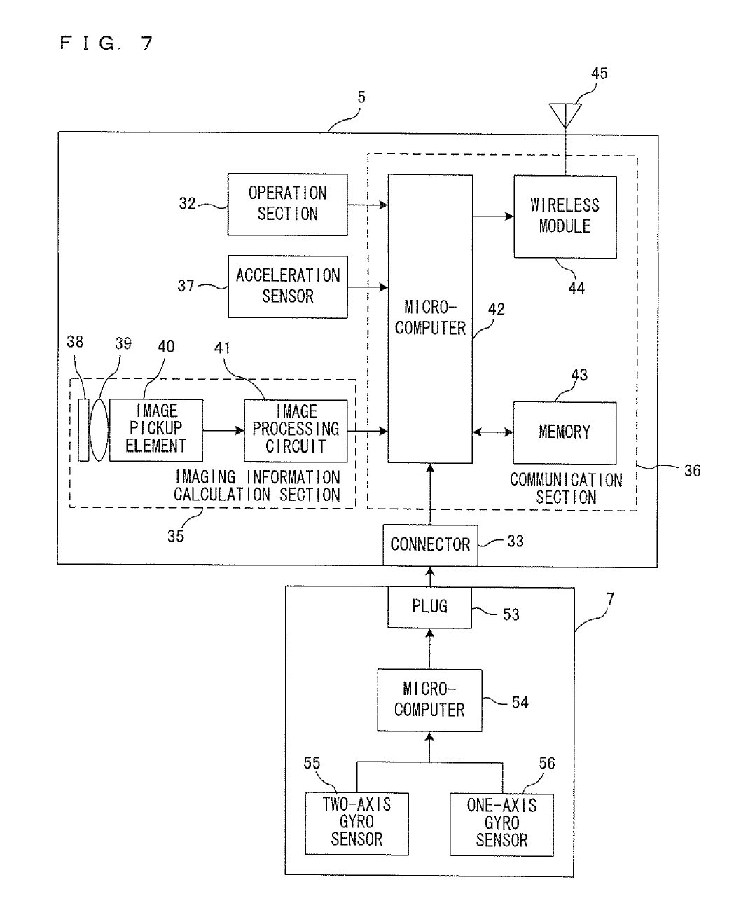

FIG. 7 is a block diagram illustrating a configuration of the input device 8 (the controller S and the gyro sensor unit 7). The controller 5 includes the operation section 32 (operation buttons 32a to 32i), the connector 33, the imaging information calculation section 35, the communication section 36, and the acceleration sensor 37. The controller 5 transmits data representing the contents of the operation performed on the controller 5 itself, as operation data, to the game apparatus 3.

The operation section 32 includes the operation buttons 32a to 32i described above, and outputs, to the microcomputer 42 of the communication section 36, operation button data representing an input state of each of the operation buttons 32a to 32i (that is, indicating whether each of the operation buttons 32a to 32i has been pressed).

The imaging information calculation section 35 is a system for analyzing data of an image taken by the imaging means, identifying an area thereof having a high brightness, and calculating the position of the center of gravity in the area and the size of the area. The imaging information calculation section 35 has, for example, a maximum sampling period of about 200 frames/sec., and therefore can trace and analyze even a relatively fast movement of the controller 5.

The imaging information calculation section 35 includes the infrared filter 38, the lens 39, the image pickup element 40, and the image processing circuit 41. The infrared filter 38 allows only infrared light to pass therethrough, among light incident on the front surface of the controller 5. The lens 39 collects the infrared light which has passed through the infrared filter 38 and outputs the infrared light to the image pickup element 40. The image pickup element 40 is a solid-state image pickup device such as, for example, a CMOS sensor or a CCD sensor. The image pickup element 40 receives the infrared light collected by the lens 39, and outputs an image signal. The markers 6R and 6L of the marker section 6 provided in the vicinity of the display screen of the television 2 are each implemented as an infrared LED for outputting infrared light forward of the television 2. Therefore, the infrared filter 38 enables the image pickup element 40 to receive only infrared light having passed through the infrared filter 38, and to generate image data, so that the images of the markers 6R and 6L can be taken with enhanced accuracy. Hereinafter, the images taken by the image pickup element 40 are referred to as a taken image. The image data generated by the image pickup element 40 is processed by the image processing circuit 41. The image processing circuit 41 calculates the position of an imaging subject (the markers 6R and 6L) in the taken image. The image processing circuit 41 outputs a coordinate representing the calculated position, to the microcomputer 42 of the communication section 36. The data representing the coordinate is transmitted as operation data to the game apparatus 3 by the microcomputer 42. Hereinafter, the coordinate is referred to as a “marker coordinate”. The marker coordinate position is different depending on an orientation (tilt angle) and a position of the controller 5 itself. Therefore, the game apparatus 3 can use the marker coordinate to calculate the orientation and the position of the controller 5.

It is to be noted that, in another embodiment, the controller 5 may not necessarily include the image processing circuit 41, and the taken image itself may be transmitted from the controller 5 to the game apparatus 3. In this case, the game apparatus 3 has a circuit or a program having a function equivalent to that of the image processing circuit 41, and may calculate the marker coordinate.

The acceleration sensor 37 detects an acceleration (including a gravitational acceleration) of the controller 5. Namely, the acceleration sensor 37 detects a force (including the gravitational force) applied to the controller 5. The acceleration sensor 37 detects a value of the acceleration (linear acceleration) in the straight line direction along the sensing axis direction, among accelerations applied to the detection section of the acceleration sensor 37. For example, in the case of the two-axis acceleration sensor or other multi-axis acceleration sensors, an acceleration of a component along each axis is detected as an acceleration applied to the detection section of the acceleration sensor. For example, the three-axis or two-axis acceleration sensor may be of the type available from Analog Devices, Inc. or STMicroelectronies N.V. The acceleration sensor 37 is of an electrostatic capacitance type in the present embodiment. However, another type of acceleration sensor may be used.

In the present embodiment, the acceleration sensor 37 detects a linear acceleration in three axial directions, i.e., the up/down direction (the direction of the Y axis shown in FIG. 3), the left/right direction (the direction of the X axis shown in FIG. 3), and the forward/backward direction (the direction of the Z axis shown in FIG. 3) relative to the controller 5. The acceleration sensor 37 detects an acceleration in the straight line direction along each axis. Therefore, an output from the acceleration sensor 37 represents a value of a linear acceleration of each of the three axes. Namely, the detected acceleration is represented as a three-dimensional vector (ax, ay, az) of the XYZ-coordinate system (the controller coordinate system) defined relative to the input device 8 (the controller 5). Hereinafter, a vector having, as components, the acceleration values which are associated with the three axes, respectively, and detected by the acceleration sensor 37, is referred to as an acceleration vector.

Data (acceleration data) representing an acceleration detected by the acceleration sensor 37 is outputted to the communication section 36. The acceleration detected by the acceleration sensor 37 varies according to the orientation (tilt angle) and the movement of the controller 5 itself. Therefore, the game apparatus 3 is able to calculate the orientation and the movement of the controller 5, by using the acceleration data. In the present embodiment, the game apparatus 3 determines the orientation of the controller 5 based on the acceleration data.

When a computer such as a processor (for example, the CPU 10) of the game apparatus 3 or a processor (for example, the microcomputer 42) of the controller 5 performs a process based on a signal of an acceleration outputted by the acceleration sensor 37, additional information relating to the controller 5 can be inferred or calculated (determined), as one skilled in the art will readily understand from the description herein. For example, a case where the computer will perform a process assuming that the controller 5 including the acceleration sensor 37 is in a static state (that is, a case where it is anticipated that an acceleration detected by the acceleration sensor will include only a gravitational acceleration) will be described. When the controller 5 is actually in the static state, it is possible to determine whether or not the controller 5 tilts relative to the gravity direction and to also determine a degree of the tilt, based on the acceleration having been detected. Specifically, when a state where 1 G (gravitational acceleration) is applied to a detection axis of the acceleration sensor 37 in the vertically downward direction represents a reference, it is possible to determine whether or not the controller 5 tilts relative to the vertically downward direction, based on whether or not 1 G is applied in the direction of the detection axis of the acceleration sensor. Further, it is possible to determine a degree to which the controller 5 tilts relative to the reference, based on a magnitude of the acceleration applied in the direction of the detection axis. Further, the acceleration sensor 37 capable of detecting an acceleration in multiaxial directions subjects, to a processing, the acceleration signals having been detected in the respective axes so as to more specifically determine the degree to which the controller 5 tilts relative to the gravity direction. In this case, based on the output from the acceleration sensor 37, the processor may calculate an angle at which the controller 5 tilts, or may calculate a direction in which the controller 5 tilts without calculating the angle of the tilt. Thus, when the acceleration sensor 37 is used in combination with the processor, an angle of the tilt or an orientation of the controller 5 can be determined.

On the other hand, in a case where it is anticipated that the controller 5 will be in a dynamic state (a state in which the controller 5 is being moved), the acceleration sensor 37 detects an acceleration based on a movement of the controller 5, in addition to the gravitational acceleration. Therefore, when the gravitational acceleration component is eliminated from the detected acceleration through a predetermined process, it is possible to determine a direction in which the controller 5 moves. Further, even when it is anticipated that the controller 5 will be in the dynamic state, the acceleration component based on the movement of the acceleration sensor is eliminated from the detected acceleration through a predetermined process, whereby it is possible to determine the tilt of the controller 5 relative to the gravity direction. In another embodiment, the acceleration sensor 37 may include an embedded processor or another type of dedicated processor for performing predetermined processing of acceleration signals detected by the incorporated acceleration detection means prior to outputting the acceleration signals to the microcomputer 42. For example, when the acceleration sensor 37 is intended to detect static acceleration (for example, gravitational acceleration), the embedded or dedicated processor could convert the acceleration signal to a corresponding tilt angle (or another preferable parameter).

The communication section 36 includes the microcomputer 42, a memory 43, the wireless module 44, and the antenna 45. The microcomputer 42 controls the wireless module 44 for wirelessly transmitting, to the game apparatus 3, data obtained by the microcomputer 42 while using the memory 43 as a storage area during the processing. The microcomputer 42 is connected to the connector 33. Data transmitted from the gyro sensor unit 7 is inputted to the microcomputer 42 through the connector 33.

The gyro sensor unit 7 includes a plug 53, a microcomputer 54, and gyro sensors 55 and 56. As described above, the gyro sensor unit 7 detects an angular velocity around each of the three axes (in the present embodiment, the XYZ-axes), and transmits, to the controller 5, data (angular velocity data) representing the detected angular velocity.

Data representing the angular velocity detected by the gyro sensors 55 and 56 is outputted to the microcomputer 54. Therefore, data representing the angular velocity around each of the three axes, that is, the XYZ-axes, is inputted to the microcomputer 54. The microcomputer 54 transmits the data representing the angular velocity around each of the three axes, as angular velocity data, to the controller 5 via a plug 53. The transmission from the microcomputer 54 to the controller 5 is sequentially performed at predetermined time intervals. The game process is typically performed in 1/60 seconds (one frame time) cycle. Therefore, the transmission is preferably performed at the intervals of 1/60 seconds or shorter intervals.

Further, in the present embodiment, the three axes which are used by the gyro sensors 55 and 56 for detecting the angular velocities are set so as to match with the three axes (the XYZ-axes) which are used by the acceleration sensor 37 for detecting accelerations. This is because, in this case, calculation performed in an orientation calculation process described below is facilitated. However, in another embodiment, the three axes which are used by the gyro sensors 55 and 56 for detecting the angular velocities may not necessarily match with the three axes which are used by the acceleration sensor 37 for detecting accelerations.

[Outline of Game Process]

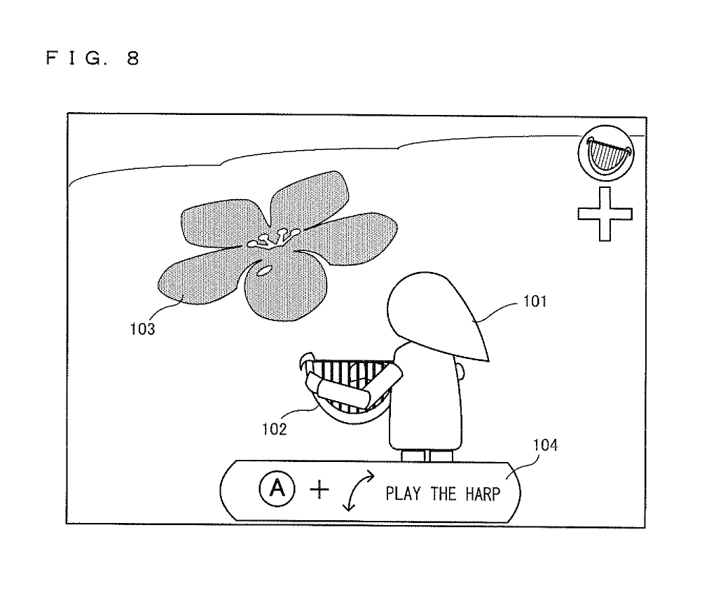

Next, an outline of a game process according to the present embodiment will be described with reference to FIG. 8 to FIG. 11. A game described in the present embodiment is a game for operating a player object in a virtual space by moving the input device 8 itself. The game process described in the present embodiment is a process for causing the player object to perform an action of playing the harp.

FIG. 8 shows an exemplary game image which is displayed when the player object plays the harp. In the game image shown in FIG. 8, a player object 101 holds a harp 102. In the present embodiment, the harp 102 has twelve strings, and can produce twelve kinds of sounds. Further, a music performing object 103 is in front of the player object 101 in the virtual space. The music performing object 103 is a flower-shaped object. In the game according to the present embodiment, when the player object 101 plays the harp 102 in front of the music performing object 103, sound is outputted from the harp 102 and sound is outputted also from the music performing object 103. Further, plural kinds of music performing objects in addition to the music performing object 103 shown in FIG. 8 exist, outputted tone is different for each music performing object (for example, voice may be outputted depending on the music performing object).

Next, an operation performed when the player object 101 plays the harp 102 will be described. Firstly, when the “upward direction” of the cross button 32a is pressed in a state where the player object 101 does not hold the harp 102, the player object 101 holds the harp 102 at the ready with its left arm as shown in FIG. 8. In this state, the right hand of the player object 101 is positioned on a string of the harp 102. Further, at this time, an operation guidance 104 is also displayed on a screen. A player preferably poses in the same manner as the player object 101 (the player poses so as to hold the harp 102 at the ready with her/his left arm), and moves her/his right hand with which the input device 8 is held while pressing the A button 32d (an orientation of the input device 8 at this time will be described below) as if the player plunks strings of the harp (namely, the player shakes the input device 8). Then, according to the movement (orientation) of the input device 8, the right arm of the player object 101 moves in a portion of the strings of the harp 102, and sound is outputted from the harp 102. Namely, the harp 102 can be played by the input device 8 itself being moved. At this time, a sound, among the twelve kinds of sounds, to be outputted is determined according to the orientation of the input device 8. In the present embodiment, sound is produced only while the A button 32d is pressed. Therefore, even in a case where the input device 8 is moved, if the A button 32d is not pressed, no sound is produced by the harp 102. However, the right arm of the player object 101 is moved. Namely, the right arm is merely moved without touching any string.

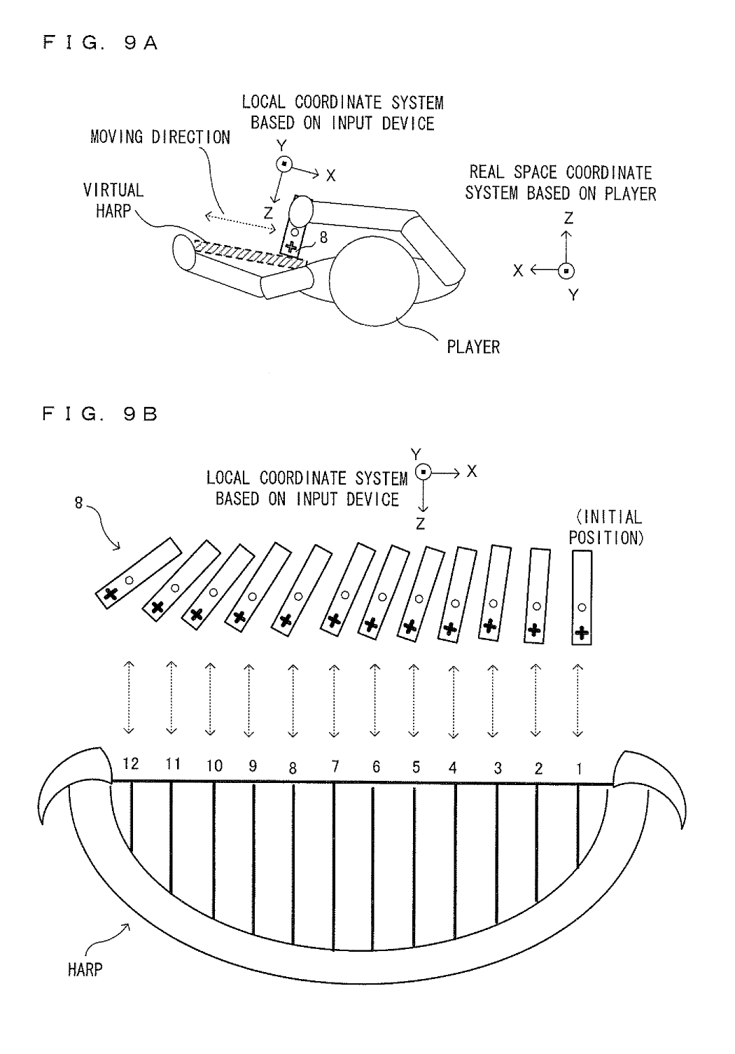

A correspondence relationship between an orientation of the input device 8 and each string of the harp 102 will be described with reference to FIG. 9. As a pose for playing the harp 102, a pose in which the harp 102 is held with the left hand, and the strings are plunked by moving the right hand will be described. The following pose and action are imaged as a pose and action performed by a player in practice. That is, as shown in FIG. 9A, on the assumption that the player holds the harp with her/his left hand, the player spreads her/his left arm leftward relative to the player. The player holds the substantially lower half portion of the input device 8 with her/his right hand such that the top surface of the input device 8 is oriented upward (in the Y-axis positive direction of a real space coordinate system). The player acts as if the player plays the virtual harp with the tip (the front surface of the housing 31, the side on which the light incident surface 35a is provided) of the input device 8 (this can be regarded as a rotation around the Y axis in a local coordinate system based on the input device 8), thereby playing the harp. FIG. 9B is a diagram illustrating a correspondence relationship between the twelve strings of the harp, and change in orientation of the input device 8 based on the movement of the input device. In the present embodiment, the initial position of the right hand of the player object 101 is a position of the endmost string (in FIG. 9B, the rightmost string denoted as “1”) of the harp 102 when an operation for holding the harp 102 at the ready is performed. When the player moves the input device 8 itself rightward and leftward (corresponding to the direction almost along the X-axis direction in the real space coordinate system, and rotation around the Y axis in the local coordinate system), as viewed from the player, relative to the initial position, while pressing the A button 32d, the orientation of the input device 8 is gradually changed, as shown in FIG. 9B, from the orientation (orientation at the initial position) of the input device 8 in a state where the harp 102 is held at the ready. Sound of each string of the harp 102 is produced according to the changed orientation (difference from the orientation at the initial position). As will be described below in detail, in the present embodiment, this change (shaking operation) is mainly handled as change of an angular velocity, thereby performing various processes.

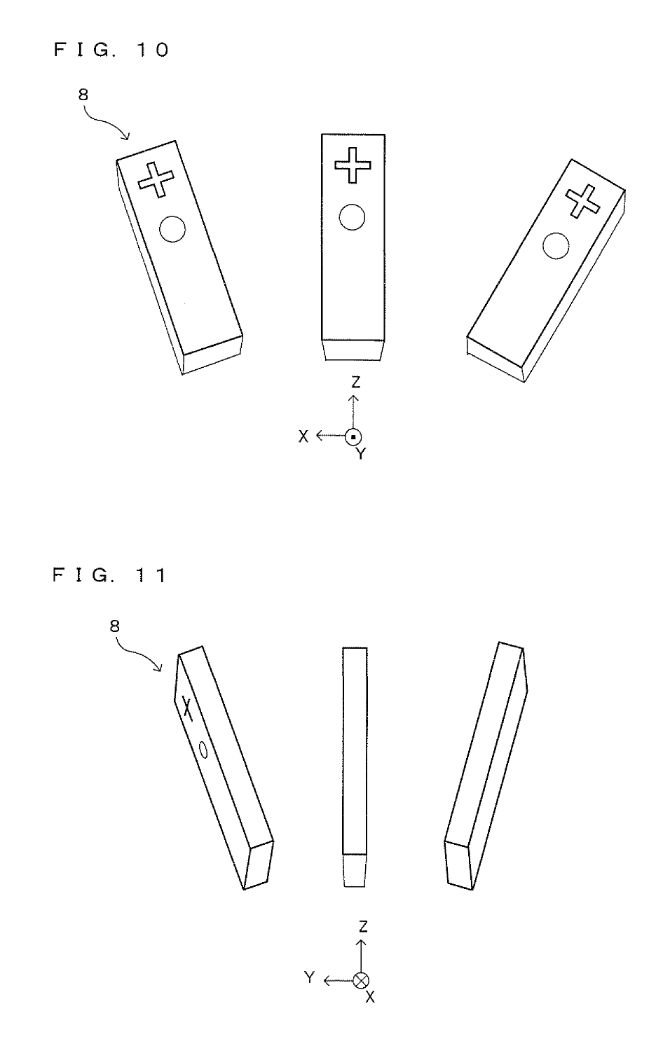

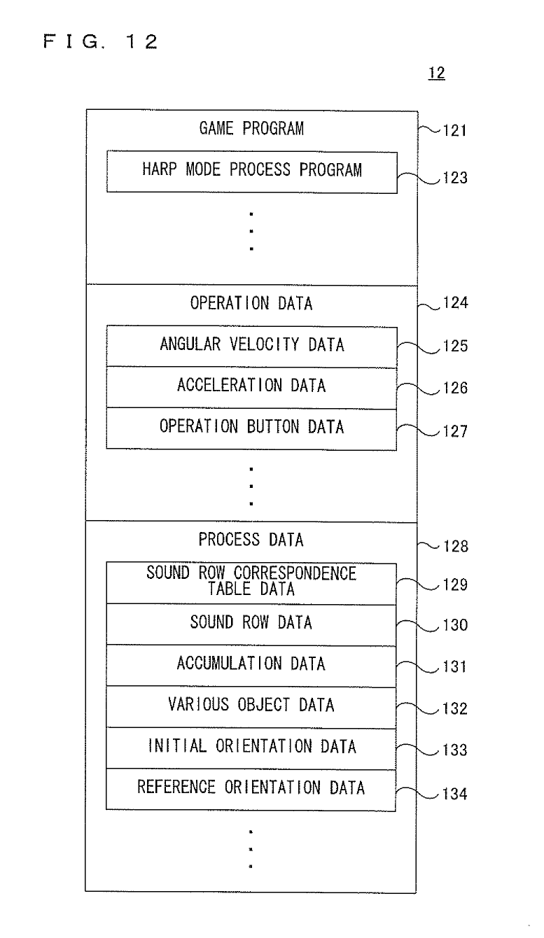

In the game process according to the present embodiment, a movement shown in FIG. 10 basically represents a basic movement (shaking manner) of the input device for playing the harp 102. Specifically, the input device 8 is moved basically on the assumption that the input device 8 is in an orientation in which the top surface (the surface on which the cross key 32a and the like are provided) is oriented upward, and the top surface is parallel to the ground so as to be horizontal (in other words, an orientation in which the longitudinal direction of the input device 8 is orthogonal to the string portion of the harp 102). Further, the input device 8 is shaken leftward and rightward (is moved along the X-axis direction, and is rotated around the Y axis) by flexibly twisting the wrist (it is a movement of pivoting on the wrist or an elbow) on the assumption that the orientation is maintained so as to be horizontal. However, when the shaking operation is actually performed, “tilt” may occur in the orientation of the input device 8. For example, when the shaking is started, the top surface of the input device 8 is oriented upward. However, toward the end of the shaking, the top surface of the input device 8 may be oriented leftward. Namely, the orientation of the input device 8 may be changed in some cases such that the input device 8 is titled 90 degrees relative to the orientation at the start of the shaking. If the input device 8 is in such an orientation, even when a player intends to shake the input device 8 leftward and rightward, shaking of the input device 8 along the upward/downward direction (movement along the Y-axis direction, and rotation around the X axis) relative to the input device 8 itself may occur (may be detected) as shown in FIG. 11. Therefore, in a case where a process of producing a sound of each string of the harp is performed only on the assumption that the input device 8 is shaken along the left-right direction while being maintained so as to be in the horizontal orientation as shown in FIG. 10, the shaking of the input device 8 along the left-right direction cannot be accurately detected when the input device 8 is in the tilted state, and sound may not be produced by the harp 102 according to the operation performed by the player. Therefore, in the game process according to the present embodiment, such a “tilt” is taken into consideration. Specifically, whether the input device 8 is in the tilted orientation is determined, and when the input device 8 is not tilted, the shaking along the left-right direction is utilized as it is, so as to calculate the orientation of the input device, thereby producing a sound of each string of the harp 102 according to the orientation. On the other hand, when the input device 8 is tilted, the shaking along the upward-downward direction is transformed into the shaking along the left-right direction, to produce a sound of each string of the harp 102 according to the orientation of the input device 8. Namely, when the input device 8 is tilted rightward relative to the orientation in which the top surface of the input device 8 is oriented upward, the shaking of the input device 8 in the upward direction in the coordinate system of the input device 8 is transformed into the shaking of the input device 8 in the rightward direction, and the shaking of the input device 8 in the downward direction in the coordinate system of the input device 8 is transformed into the shaking of the input device 8 in the leftward direction. On the other hand, when the input device 8 is tilted leftward (as shown in FIG. 11), the shaking of the input device 8 in the upward direction in the coordinate system of the input device 8 is transformed into the shaking of the input device 8 in the leftward direction, and the shaking of the input device 8 in the downward direction in the coordinate system of the input device 8 is transformed into the shaking of the input device 8 in the rightward direction. Namely, transformation into a shaking direction (direction of rotation around the Y axis) based on the assumption that the top surface of the input device 8 is constantly oriented upward, is performed. As described above, when the process is performed in consideration of the “tilt” in orientation, occurrence of inconsistency between an action performed by a player, and a sound produced by the harp 102 according to the player's action, and uncomfortableness caused by the inconsistency can be prevented.

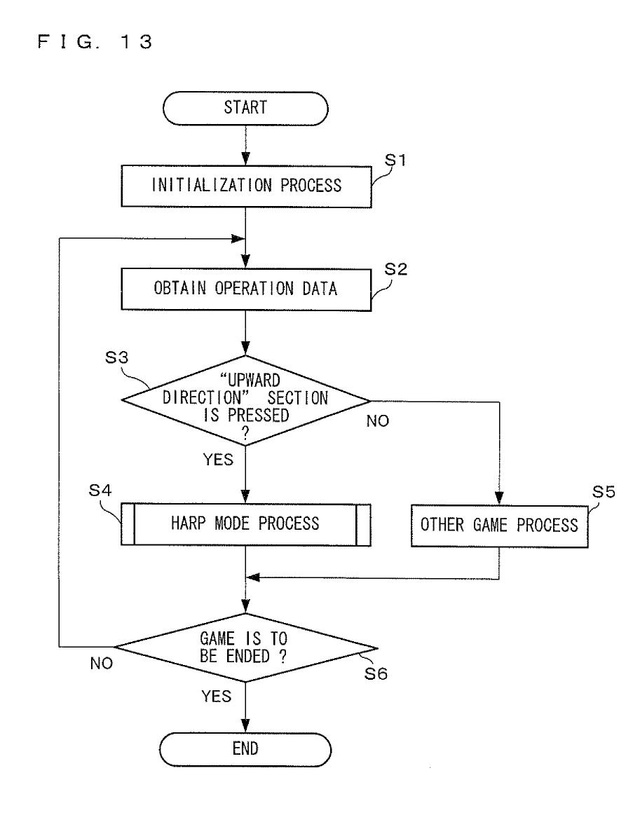

Next, the game process performed by the game apparatus 3 will be described in detail. Firstly, main data to be used in the game process will be described with reference to FIG. 12. FIG. 12 is a diagram illustrating main data to be stored in the main memory (the external main memory 12 or the internal main memory 11e) of the game apparatus 3. In the main memory of the game apparatus 3, a game program 121, operation data 124, and process data 128 are stored. In addition thereto, various data, such as image data of various objects appearing in the game, necessary for the game process is stored in the main memory.

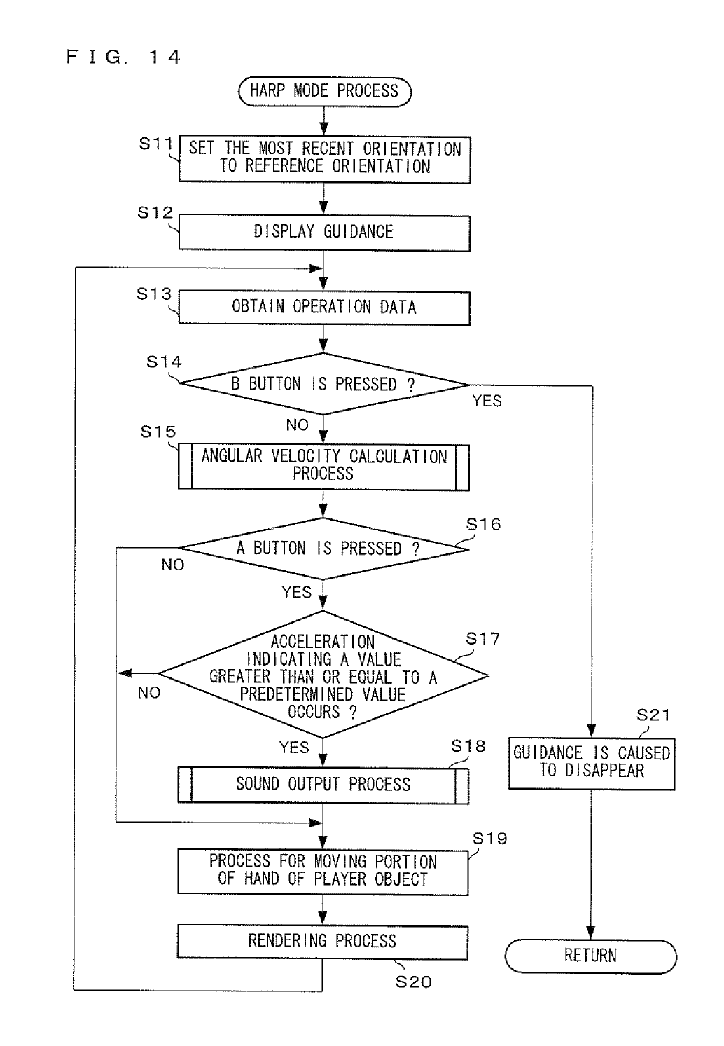

The game program 121 is a program for a process of the flow chart shown in FIG. 13, which will be described below. The game program 121 includes, for example, a harp mode process program 123.

The operation data 124 is operation data transmitted from the input device 8 to the game apparatus 3. In the present embodiment, the operation data is transmitted from the input device 8 to the game apparatus 3 every 1/200 seconds. Therefore, the operation data 124 stored in the main memory is updated in this cycle. In the present embodiment, only the most recent (most recently obtained) operation data may be stored in the main memory.

The operation data 124 includes angular velocity data 125, acceleration data 126, operation button data 127, and the like. The angular velocity data 125 represents an angular velocity detected by the gyro sensors 55 and 56 of the gyro sensor unit 7. In the present embodiment, the angular velocity data 125 represents an angular velocity around each of the three axes, that is, the XYZ axes shown in FIG. 3. Further, the acceleration data 126 represents an acceleration (acceleration vector) detected by the acceleration sensor 37. In the present embodiment, the acceleration data 126 represents a three-dimensional acceleration vector including, as components, accelerations associated with the directions of the three axes, that is, the XYZ-axes shown in FIG. 3. Further, in the present embodiment, the magnitude of the acceleration vector detected by the acceleration sensor 37 in a state where the controller 5 is stationary indicates “1”. Namely, the magnitude of the gravitational acceleration detected by the acceleration sensor 37 indicates “1”.

The operation button data 127 represents an input state of each of the operation buttons 32a to 32i.

The process data 128 is used for obtaining difference occurring in the game process, and includes various data such as sound row correspondence table data 129, sound row data 130, accumulation data 131, various object data 132, initial orientation data 133, and reference orientation data 134.

The sound row correspondence table data 129 is data representing a table in which a correspondence between the sound row of sounds produced by the music performing object 103, and the twelve kinds of sounds of the harp 102 is defined. The table is defined for each of the music performing objects 103.

The sound row data 130 is data determined based on the orientation of the input device 8, and indicates one of the twelve kinds of sounds of the harp 102, which corresponds to the orientation of the input device 8 obtained at a certain time point.

The accumulation data 131 is used for calculating the sound row data, and represents an accumulation of the angular velocities calculated in each frame.

The various object data 132 is data for various objects, such as the player object 101 and the music performing object 103, appearing in the game.

The initial orientation data 133 is data which is set in the game initialization process described below when the game process is started. The initial orientation data 133 is used for calculating the orientation of the input device 8 in the game process.

The reference orientation data 134 represents an orientation of the input device 8 obtained when the player object is caused to hold the harp 102 at the ready (when the “upward direction” of the cross key 32a is pressed). The reference orientation data 134 is used for determining a sound, among the twelve kinds of sounds, to be produced by the harp 102 when the harp is played.

Next, the game process according to the present embodiment will be specifically described. FIG. 13 is a flow chart showing in detail the entirety of the game process. With reference to the flow chart shown in FIG. 13, among the game processes, a process for causing the player object to play the harp as described above will be mainly described, and detailed description of other processes which are not directly associated with the present invention is omitted. Further, a process loop of steps S2 to S6 shown in FIG. 13, and a process loop of steps S13 to S20 shown in FIG. 14 described below are each repeatedly performed every one frame.

Firstly, in step S1, an initialization process is performed. In the initialization process, various data used in the game process is initialized, a virtual game space is structured, and a game image obtained by taking an image of the virtual game space by using a virtual camera is displayed, for example. Further, an initialization process for an orientation of the input device 8 is also performed. In the initialization process for an orientation of the input device 8, for example, the following process is performed. Firstly, an instruction for putting the input device 8 on a level place so as to orient the top surface of the input device 8 downward is indicated on the screen. When a player puts the input device 8 on a level place according to the instruction, the gyro sensor unit 7 is initialized based on the orientation determined at this time. The “initial orientation” of the input device is determined based on the orientation of the input device 8 obtained at this time, and is set to the initial orientation data 133. In the present embodiment, the initial orientation is an orientation in which the top surface of the input device 8 is oriented upward (namely, an orientation reverse of the orientation obtained when the input device is put on the level place). In the subsequent game process, an orientation of the input device 8, and the like are calculated, in the process of each frame, according to, for example, the comparison with the initial orientation.

After the initialization process has been completed, the operation data 124 is obtained in step S2. Subsequently, in step S3, whether an operation for instructing the player object to hold the harp at the ready as described above is performed is determined with reference to the operation button data 127 of the operation data 124. For example, in the present embodiment, the pressing of the “upward direction” section of the cross key 32a corresponds to this instruction. When the result of the determination indicates that the “upward direction” section is pressed (YES in step S3), a harp mode process described below is performed in step S4. On the other hand, when the “upward direction” section is not pressed (NO in step S3), various other processes of the game process are performed in step S5 as necessary. In another embodiment, another button may be used for instruction for holding the harp at the ready, and an operation other than pressing of a predetermined button may be performed for the instruction for holding the harp at the ready.

FIG. 14 is a flow chart showing in detail the harp mode process of step S4. This process is a process for causing the player object 101 to play the harp 102. Firstly, in step S11, the most recently obtained orientation (hereinafter, referred to as a “most recent orientation”) of the input device 8 is calculated. The most recent orientation of the input device 8 is calculated based on, for example, the acceleration data 126 and the angular velocity data 125 obtained from the operation data 124, and the initial orientation. The most recent orientation having been thus obtained is set to a “reference orientation” used in the subsequent process steps, and is stored as the reference orientation data 134.

Next, in step S12, the operation guidance 104 as shown in FIG. 8 is displayed on the screen.

Next, in step S13, the operation data 124 is obtained. Subsequent thereto, whether the B button 32i is pressed is determined in step S14. In the present embodiment, the B button 32i acts as a button for ending the harp mode process (namely, for stopping the music performance of the harp). When the result of the determination indicates that the B button 32i is pressed (YES in step S14), the operation guidance 104 is caused to disappear from the screen in step S21. The harp mode process is also ended.

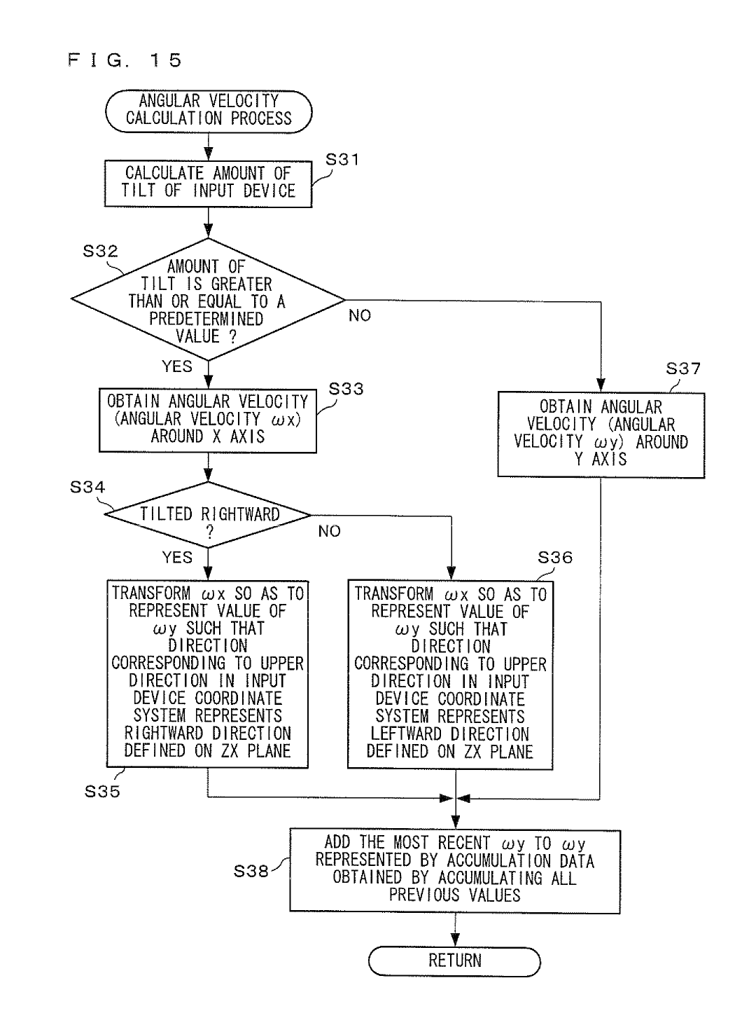

On the other hand, when the B button 32i is not pressed (NO in step S14), an angular velocity calculation process is subsequently performed in step S15. FIG. 15 is a flow chart showing in detail the angular velocity calculation process of step S15. Firstly, in step S31, an amount of tilt of the input device 8 is calculated. In this process step, for example, the most recent orientation is compared with the initial orientation, to calculate an amount of tilt relative to the initial orientation.

Next, in step S32, whether the amount of the tilt of the input device is greater than or equal to a predetermined amount is determined. For example, whether the input device is tilted by 45 degrees or more around the Z axis relative to the initial orientation (the orientation of the input device in the case of the top surface being parallel to the ground so as to be horizontal), is determined. When the result of the determination indicates that the amount of tile is less than the predetermined amount (NO in step S32), no tilt occurs. Namely, the input device 8 is determined as being in a horizontal orientation. Therefore, in step S37, an angular velocity (hereinafter, referred to as an angular velocity ωy) around the Y axis in the coordinate system of the input device 8 is obtained. Namely, an angular velocity based on the shaking action as shown in FIG. 10 is obtained. Further, at this time, the rotating direction (positive or negative) is also determined. Thereafter, the process is advanced to step S38 described below.

On the other hand, when the result of the determination of step S32 indicates that the amount of the tilt is greater than or equal to the predetermined amount (YES in step S32), the input device 8 may be in an orientation in which the input device 8 is tilted relative to the initial orientation. Therefore, in step S33, an angular velocity (hereinafter, referred to as an angular velocity ωx) around the X axis is obtained.

Next, in step S34, whether the input device 8 is tilted rightward is determined. When the result of the determination indicates that the input device 8 is tilted rightward (YES in step S34), the angular velocity ωx is transformed so as to represent a value of the angular velocity ωy in step S35 such that the upward direction of the coordinate system of the input device 8 represents the rightward direction defined on the ZX plane when the input device 8 is in the horizontal orientation.

On the other hand, when the input device 8 is not tilted rightward, namely, when the input device 8 is tilted leftward (NO in step S34), the angular velocity ωx is transformed so as to represent a value of the angular velocity ωy in step S36 such that the upward direction of the coordinate system of the input device 8 represents the leftward direction defined on the ZX plane when the input device 8 is in the horizontal orientation.

Next, in step S38, the angular velocity ωy obtained or calculated by the transformation is added to a value represented by the accumulation data 131. The accumulation data 131 indicates a value which is obtained by accumulating the angular velocities ωy having been previously obtained. When the obtained or calculated angular velocity ωy represents a negative value, the obtained or calculated angular velocity ωy is subtracted from a value represented by the accumulation data 131, and when the obtained or calculated angular velocity ωy represents a positive value, the obtained or calculated angular velocity ωy is added to a value represented by the accumulation data 131. Thus, consideration as to whether the input device is shaken rightward or leftward can be made. As a result, the orientation of the input device 8 based on the assumption that the top surface of the input device 8 is oriented upward can be calculated according to the accumulation data 131. This is the end of the angular velocity calculation process.

Returning to FIG. 14, after the angular velocity calculation process has been completed, whether the A button 32d is pressed is determined in step S16. As described above, in the present embodiment, sound is produced by the harp 102 only when the A button 32d is pressed. Therefore, in step S16, whether sound is to be produced by the harp 102 is determined. When the result of the determination indicates that the A button 32d is not pressed (NO in step S16), sound need not be produced by the harp 102. Therefore, the process is advanced to the process step of step S19 described below.

On the other hand, when the A button 32d is pressed (YES in step S16), whether an acceleration indicating a value greater than or equal to a predetermined value has occurred is determined, in step S17, with reference to the operation data 124. Namely, whether shaking of the input device 8 is relatively great is determined. Further, the shaking direction is determined, specifically, whether shaking (acceleration) of the input device 8 is performed in the direction (the axial direction parallel to the alignment of the strings) along the alignment of the strings of the harp 102 is determined. In the example shown in FIG. 10, whether leftward or rightward shaking which has a relatively great acceleration has occurred is determined. This is because, for example, a minute movement, such as jiggling of a hand, occurring in the input device 8 is ignored, and only when a relatively great movement has occurred, it is determined that sound is to be produced by the harp 102. When the result of the determination indicates that an acceleration indicating a value greater than or equal to the predetermined value does not occur (NO in step S17), the process is advanced to step S19 described below without producing sound by the harp 102.

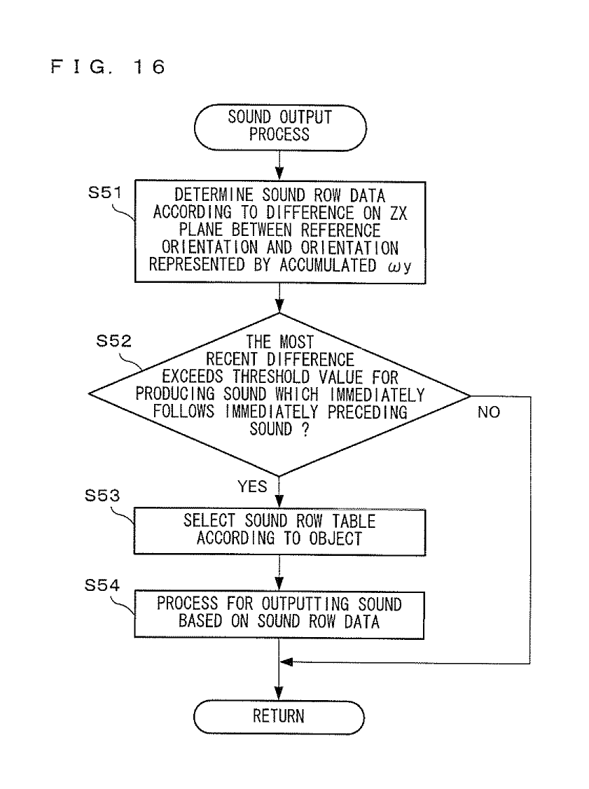

On the other hand, when an acceleration indicating a value greater than or equal to the predetermined value has occurred (YES in step S17), a sound output process for producing sound by the harp is performed in step S18. FIG. 16 is a flow chart showing in detail the sound output process of step S18. Firstly, in step S51, a difference between the reference orientation, and an input orientation represented by the angular velocity ωy obtained by the accumulation, is calculated. Further, based on the difference, the sound row data corresponding to one of the twelve kinds of sounds of the harp 102 is determined. Namely, one sound corresponding to the most recent orientation of the input device relative to the reference orientation, is selected from among twelve steps of sounds represented as the sound row data.

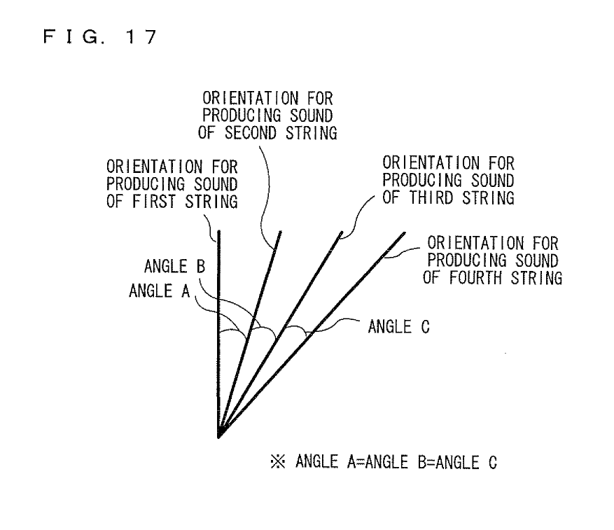

Next, in step S52, it is determined whether the orientation of the input device 8 represented by the most recently calculated difference has been changed from the immediately preceding orientation in which sound has been produced, by a change amount which exceeds a threshold value for producing the immediately following string sound. For example, as shown in FIG. 17, whether the orientation of the input device 8 has been changed to the orientation corresponding to the second string after production of sound by the first string, is determined. Namely, whether the orientation has been changed by a change amount which exceeds the threshold value represented as an angle A, after production of sound by the first string, is determined (in other words, the threshold value conceptually represents a distance or a space between the strings). Further, for example, it is determined whether the orientation of the input device 8 has been changed by a change amount which exceeds a threshold value represented as an angle B, after production of sound by the second string. This determination may be performed by determining whether an angular velocity obtained up to the most recent frame after the most recent production of sound has exceeded the threshold value (in FIG. 17, the angle A, the angle B, and an angle C indicate the same value). Further, in the present embodiment, a case where the strings are plunked to produce sound in the order from the first string toward the second string is described. However, also when the strings are plunked to produce sound in the reverse order, the determination is made according to whether the threshold value has been exceeded as described above. For example, in a case where, after sound has been produced by plunking the second string, the input device 8 is shaken in the opposite direction before the third string is plunked to produce sound (namely, when only the second string is plunked to produce sound by small reciprocating motion), it is determined, instead of determining whether the threshold value has been exceeded, whether the input device 8 is returned to the orientation in which the sound has been produced by plunking the second string although an angular velocity in the direction of the third string or the first string has been obtained after production of the sound by the second string. Thus, sound of the second string may be produced as necessary.

The determination using a threshold value as described below may be performed. Namely, a difference from the orientation (the reference orientation) corresponding to the first string is constantly calculated, and whether sound is to be produced may be determined based on the difference. In the example shown in FIG. 17, whether the third string is plunked to produce sound is determined by determining whether the orientation has been changed relative to the reference orientation (in the present embodiment, the orientation for producing sound by the first string), by a change amount which exceeds a threshold value represented as the angle A+the angle B. Further, whether the fourth string is plunked to produce sound may be determined by determining whether the orientation has been changed relative to the reference orientation, by a change amount which exceeds s threshold value represented as the angle A+the angle B+the angle C.

When the result of the determination indicates that the threshold value for producing the immediately following string sound is exceeded (YES in step S52), the sound row correspondence table for the music performing object 103 which is in front of the player object 101 at that time is selected in step S53 with reference to the sound row correspondence table data 129.

Next, in step S54, data that represents a sound corresponding to the sound row data 130 indicating one of the twelve steps of sounds in the sound row is obtained with reference to the sound row correspondence table. The selected sound (the sound row data 130) is outputted. As a result, sound of the harp 102 based on the orientation of the input device 8 is produced, and sound corresponding to the sound row data is outputted also from the music performing object 103. This is the end of the sound output process.

On the other hand, when the result of the determination of step S52 indicates that the threshold value is not exceeded (NO in step S52), the process steps of steps S53 and S54 are skipped, and the sound output process is ended without producing any sound.

Returning to FIG. 14, in step S19, the right arm of the player object 101 is moved according to the angular velocity ωy. At this time, if the A button is not pressed, the process steps of steps S17 to S18 are skipped, so that the right arm of the player object 101 is merely moved without producing any sound by the harp 102, and the like. On the other hand, when the A button 32d is pressed, the sound is produced and the right arm is moved.

Next, in step S20, a game image is generated based on the contents of the process as described above (the movement of the arms of the player object 101, and the like), and rendered. Thereafter, the process is returned to step S13, and the process is repeated until the B button 32i is pressed. This is the end of the harp mode process.

Returning to FIG. 13, when the harp mode process has been ended, whether a condition for ending the game has been satisfied is determined in step S6. When the condition is not satisfied (NO in step S6), the process is returned to step S2, and the process steps are repeated. When the condition is satisfied (YES in step S6), the game process is ended.

As described above, in the present embodiment, the input device 8 itself is moved, and one of the twelve kinds of sounds of the harp 102 is produced based on the difference between the reference orientation and the most recent orientation (therefore, for example, when the input device 8 is shaken in one direction, an operation for plunking the strings of the harp from the first string toward the twelfth string can be performed). Thus, a minute music performance operation based on the minute movement of the input device 8 can be executed. For example, in a case where, when the harp 102 has twelve strings, all of the twelve strings of the harp 102 are sequentially plunked, an operation can be performed such that a speed (tempo) at which the first to the fifth strings are plunked, and a speed (temp) at which the sixth to the twelfth strings are plunked, are different from each other (the speed at which the input device 8 is shaken is changed between in the former half part of the operation and in the latter half part of the operation). Further, a minute operation for, for example, plunking the strings of the harp from the first string to the sixth string, and thereafter plunking the strings in the opposite direction, that is, plunking the strings of the harp from the sixth string toward the first string, can be performed.

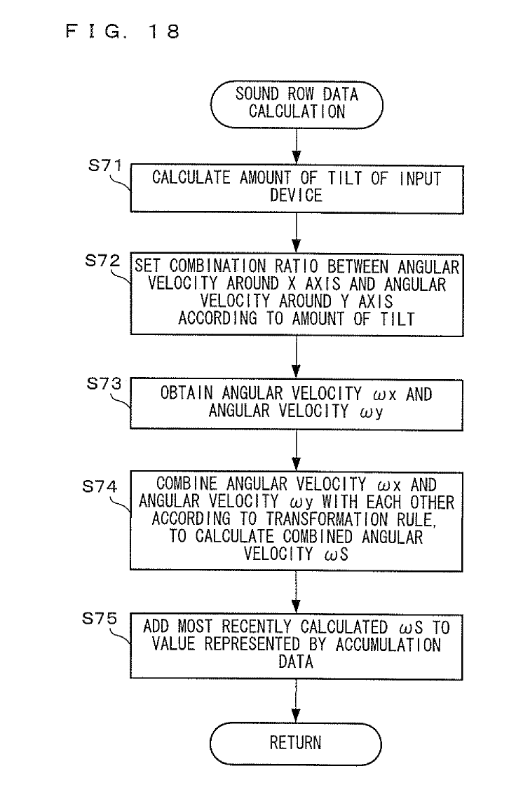

In the angular velocity calculation process, for example, the angular velocity may be calculated in a process described below, instead of the process described above. FIG. 18 is a flow chart showing an angular velocity calculation process according to another embodiment. In this process, an angular velocity around the X axis and an angular velocity around the Y axis are combined with each other, to obtain an angular velocity used for determining the sound row data 130. At this time, a combination ratio between the angular velocity around the X axis and the angular velocity around the Y axis can be determined according to an amount by which the input device 8 is tilted, thereby combining the angular velocities with each other.

In FIG. 18, firstly, in step S71, a tilt amount by which the input device 8 is tilted is calculated. This process is performed in a manner similar to the process step of step S31.

Next, in step S72, a combination ratio between an angular velocity ωy (the angular velocity around the Y axis) and an angular velocity ωx (the angular velocity around the X axis) is determined according to the calculated tilt amount. For example, the tilt amount of the input device 8 having its top surface oriented upward is defined as zero, and the tilt amount of the input device 8 having its top surface oriented leftward or rightward (when the input device 8 is tilted by 90 degrees) is defined as 100. In the case of the tilt amount indicating zero, the combination ratio between the angular velocity ωy and the angular velocity ωx is determined as, for example, “100%:0%”. On the other hand, in the case of the tilt amount indicating 100, the combination ratio between the angular velocity ωy and the angular velocity ωx is determined as “0%:100%”. Further, in the case of the tilt amount indicating 40, the combination ratio between the angular velocity ωy and the angular velocity ωx is determined as “60%:40%”.

Next, in step S73, the angular velocity ωx and the angular velocity ωy are obtained with reference to the operation data 124.

Subsequently, in step S74, the angular velocity ωx and the angular velocity ωy are combined with each other based on the combination ratio determined in step S72, to calculate a combined angular velocity ωS. The combined angular velocity ωS represents an angular velocity based on the assumption that the input device 8 is in the horizontal orientation (see FIG. 10).

Next, in step S75, the combined angular velocity ωS having been calculated is added to a value represented by the accumulation data 131. Thus, the most recent orientation of the input device 8 can be calculated, according to the combined angular velocity ωS and the reference orientation, based on the assumption that the input device 8 is in the horizontal orientation. This is the end of the description of the angular velocity calculation process according to another embodiment. The movement of the input device 8 performed by a player can be utilized, with enhanced accuracy, for output of sound of the harp 102 by such a process being performed.

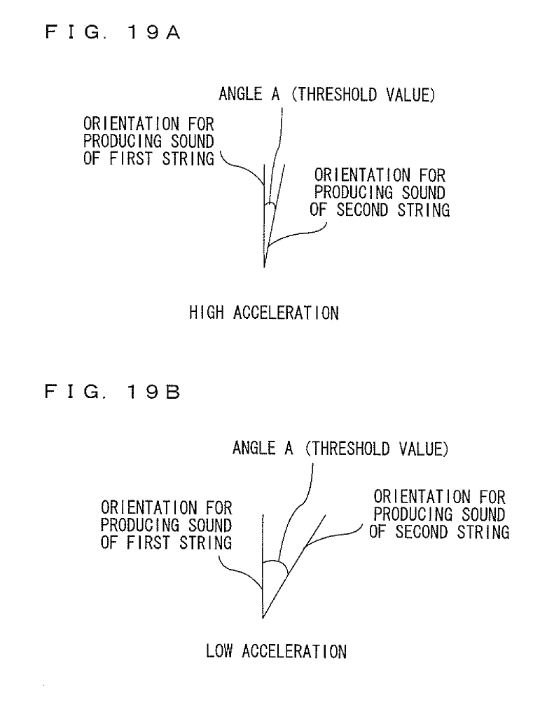

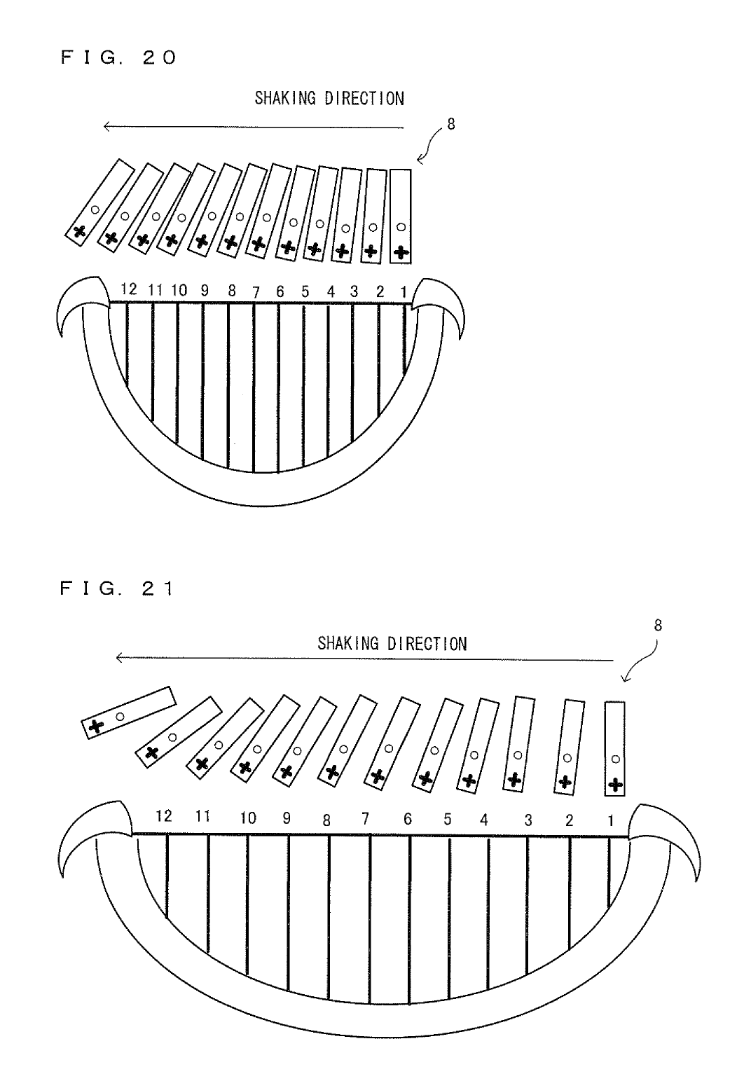

Further, in the present embodiment, after sound of a certain string is produced, whether the threshold value for producing the immediately following string sound is exceeded is determined, as shown in FIG. 17, and when the threshold value is exceeded, sound is produced, in the sound output process described above. The same threshold value is used in the embodiment described above (in FIG. 17, the angles A to C are angles indicating the same value). However, in another embodiment, the threshold value may be changed according to a speed at which the input device 8 is shaken. For example, when a speed at which the input device 8 is shaken is high (in the case of a movement indicating a great acceleration), the threshold value is determined so as to represent a reduced value (see FIG. 19A). On the other hand, when a speed at which the input device 8 is shaken is low (in the case of a movement indicating a low acceleration), the threshold value is determined so as to represent an increased value (see FIG. 19B). Namely, as described above, since the threshold value conceptually represents distances among the strings of the harp, the distances among the strings may be changed according to the magnitude of the acceleration. For example, as shown in FIG. 20, in a case where the input device 8 itself is shaken, when the acceleration is high, all of the twelve strings can be plunked to produce sound even if the change of the orientation of the input device 8 itself is small. On the other hand, in a case where the input device 8 itself is shaken, when the acceleration is low, the orientation of the input device 8 needs to be greatly changed as shown in FIG. 21 in order to plunk all of the twelve strings for producing sound, as compared to a case where the acceleration is high (the correspondence relationship between the orientation of the input device 8, and each string of the harp shown in each of FIGS. 20 and 21 is similar to that shown in FIG. 9). For the process described above, for example, the acceleration data 126 is referred to, and the threshold value which has been previously defined as an initial value may be increased or reduced according to the acceleration data 126 in step S52, thereby performing determination.

Further, data representing the orientation of the input device 8 corresponding to each string of the harp 102 may be previously defined, and whether the most recent orientation matches with the orientation represented by the previously defined data may be determined without using the threshold value described above, thereby outputting sound from each string.

Further, in the embodiments described above, the sound row data 130 is determined based on a difference between the reference orientation and the most recent orientation. In another embodiment, the sound row data 130 may be determined according to a difference between the most recent orientation and the orientation of the input device 8 obtained in the process performed in the immediately preceding frame, instead of using the reference orientation. Further, in this case, the differences may be accumulated and the accumulated difference may be stored as the accumulation data 131.

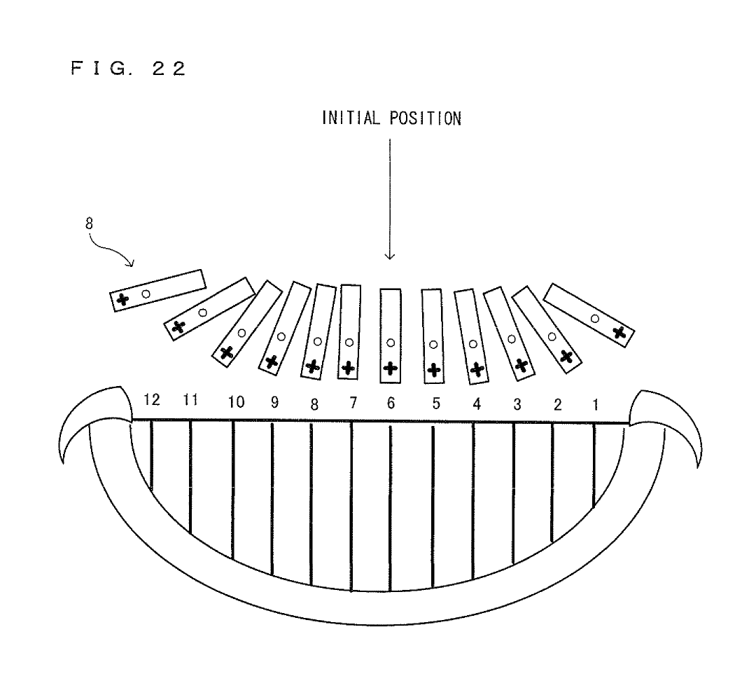

Further, in the embodiments described above, for example, a position of the endmost string of the harp 102 is determined as an initial position (an initial position of the right hand of the player object 101) for producing sound, when the “upward direction” of the cross key 32a is pressed, namely, when the player object 101 holds the harp 102 at the ready. However, the initial position is not limited thereto, and the initial position may be a position of another string, for example, a position near the center of the harp 102. For example, as shown in FIG. 22, the position of the sixth string may be used as the initial position (the positional relationship between the harp and the input device 8 shown in FIG. 22 is similar to that shown in FIG. 9). In this case, the orientation of the input device 8 corresponding to each string is changed relative to the sixth string such that the orientations for the sixth to the first strings represent orientations in which the tip portion of the input device 8 approaches a player, and the orientations for the seventh to the twelfth strings represent orientations in which the tip portion of the input device 8 is moved apart from the player.

Further, in the embodiments described above, the gyro sensor unit 7 is used (the angular velocity is used) to calculate the orientation of the input device. However, the orientation (the reference orientation and the most recent orientation) of the input device 8 may be calculated based on the acceleration data 126 obtained from the acceleration sensor 37, without using the gyro sensor unit 7.

Moreover, in the embodiments described above, a harp is used as an exemplary musical instrument used in the game. However, the present invention is not limited thereto. The present invention is applicable to any general stringed instruments. Further, the present invention is applicable to not only musical instruments such as stringed instruments, but also to any aspect in which the above-described process for determining sound to be produced, based on the difference between the most recent orientation and the reference orientation defined at a predetermined time, can be used.

Further, in the embodiments described above, a series of process steps for playing the harp 102 based on the orientation of the input device 8 is executed by a single apparatus (the game apparatus 3). In another embodiment, the series of process steps may be executed by an information processing system including a plurality of information processing apparatuses. For example, in an information processing system including a terminal-side device and a server-side device which can communicate with the terminal-side device via a network, some of the series of process steps may be executed by the server-side device. Further, in an information processing system including a terminal-side device and a server-side device which can communicate with the terminal-side device via a network, main process steps among the series of process steps described above may be executed by the server-side device, and a portion of the series of process steps may be executed by the terminal-side device. Moreover, in the information processing system, a server-side system may include a plurality of information processing apparatuses, and the plurality of information processing apparatuses may share the process steps to be executed on the server side.

While the invention has been described in detail, the foregoing description is in all aspects illustrative and not restrictive. It will be understood that numerous other modifications and variations can be devised without departing from the scope of the invention.

What is claimed is:

1. A computer-readable storage medium having stored therein a music performance program executed by a computer of a music performance apparatus for executing music performance based on an input from an input device having a movement and orientation sensor for detecting one of a movement and an orientation of the input device itself, the music performance program causing the computer to function as:
movement and orientation information obtaining means for obtaining information about one of a movement and an orientation of the input device, the one of the movement and the orientation of the input device being detected by the movement and orientation sensor;
orientation difference calculation means for calculating a difference between a predetermined reference orientation, and the orientation of the input device having been obtained by the movement and orientation information obtaining means; and
music performance means for executing music performance by producing a predetermined sound based on the difference in orientation calculated by the orientation difference calculation means.

2. The computer-readable storage medium having stored therein the music performance program according to claim 1, wherein
the music performance program causes the computer to further function as reference orientation setting means for setting, to the predetermined reference orientation, an orientation of the input device obtained at a predetermined time, and
the orientation difference calculation means calculates the difference between the predetermined reference orientation and the orientation of the input device having been obtained by the movement and orientation information obtaining means, after the predetermined reference orientation has been set.

3. The computer-readable storage medium having stored therein the music performance program according to claim 1, wherein the music performance means produces, when the difference in orientation having been calculated by the orientation difference calculation means exceeds a predetermined threshold value which is predefined for the difference in orientation, a sound according to the predetermined threshold value.

4. The computer-readable storage medium having stored therein the music performance program according to claim 3, wherein the number of the predetermined threshold values to be set is greater than one.

5. The computer-readable storage medium having stored therein the music performance program according to claim 3, wherein
the music performance program causes the computer to further function as change amount detection means for detecting an amount of change of one of the movement and the orientation of the input device per unit time, the one of the movement and the orientation of the input device having been obtained by the movement and orientation information obtaining means, and
the music performance means changes the predetermined threshold value according to the amount of change of one of the movement and the orientation.

6. The computer-readable storage medium having stored therein the music performance program according to claim 5, wherein the music performance means changes the predetermined threshold value such that the greater the amount of change of one of the movement and the orientation is, the less the predetermined threshold value is.

7. The computer-readable storage medium having stored therein the music performance program according to claim 1, wherein
the music performance program causes the computer to further function as change amount calculation means for calculating an amount of change of one of the movement and the orientation of the input device per unit time, the one of the movement and the orientation of the input device having been obtained by the movement and orientation information obtaining means, and
the music performance means changes a correspondence relationship between the difference calculated by the orientation difference calculation means, and a sound to be produced based on the difference, according to the amount of change of one of the movement and the orientation having been calculated.

8. The computer-readable storage medium having stored therein the music performance program according to claim 2, wherein
the music performance program causes the computer to further function as change amount determination means for determining, after the predetermined reference orientation is set by the reference orientation setting means, whether an amount of change of one of the movement and the orientation of the input device per unit time is greater than or equal to a predetermined amount, the one of the movement and the orientation of the input device having been obtained by the movement and orientation information obtaining means, and
the music performance means starts music performance at a time point when the change amount determination means determines that the amount of change of one of the movement and the orientation of the input device is greater than or equal to the predetermined amount.

9. The computer-readable storage medium having stored therein the music performance program according to claim 2, wherein
the input device further includes a predetermined input section,
the music performance program causes the computer to further function as input determination means for determining whether an input has been performed on the predetermined input section, and
the reference orientation setting means sets, to the predetermined reference orientation, an orientation obtained when the input determination means determines that an input has been performed on the predetermined input section.

10. The computer-readable storage medium having stored therein the music performance program according to claim 2, wherein
the input device further includes a predetermined input section,
the music performance program causes the computer to further function as input determination means for determining whether an input has been performed on the predetermined input section, and
the music performance means executes music performance only when the input determination means determines that an input is performed on the predetermined input section.

11. The computer-readable storage medium having stored therein the music performance program according to claim 1, wherein the orientation difference calculation means calculates an amount of rotation of the input device about a predetermined axis of the input device relative to the predetermined reference orientation, as the difference between the predetermined reference orientation, and the orientation of the input device having been obtained by the movement and orientation information obtaining means.

12. The computer-readable storage medium having stored therein the music performance program according to claim 11, wherein the orientation difference calculation means calculates the difference from the predetermined reference orientation, based on an amount of rotation of the input device about the predetermined axis of the input device, and an amount of rotation of the input device about an axis orthogonal to the predetermined axis.

13. The computer-readable storage medium having stored therein the music performance program according to claim 11, wherein the predetermined axis is an axis for determining a direction in which the input device is shaken.

14. The computer-readable storage medium having stored therein the music performance program according to claim 13, wherein the orientation difference calculation means transforms an amount of rotation of the input device about an axis different from the predetermined axis, into an amount of rotation of the input device about the predetermined axis, and calculates the difference based on the amount of rotation about the predetermined axis and the amount of rotation obtained through the transformation.

15. The computer-readable storage medium having stored therein the music performance program according to claim 1, wherein
the movement and orientation information obtaining means, the orientation difference calculation means, and the music performance means each repeat a process loop, and
the predetermined reference orientation is an orientation based on the information about one of the movement and the orientation of the input device which has been obtained by the movement and orientation information obtaining means in an immediately preceding process loop.

16. The computer-readable storage medium having stored therein the music performance program according to claim 15, wherein
the music performance means includes difference accumulation means for calculating an accumulation of each difference in orientation calculated by the orientation difference calculation means, and
the music performance means executes music performance based on the accumulation of each difference in orientation calculated by the difference accumulation means.

17. The computer-readable storage medium having stored therein the music performance program according to claim 1, wherein the movement and orientation sensor is an acceleration sensor and/or an angular velocity sensor.

18. A music performance apparatus for executing music performance based on an input from an input device having a movement and orientation sensor for detecting one of a movement and an orientation of the input device itself, the music performance apparatus comprising:
movement and orientation information obtaining means for obtaining information about one of a movement and an orientation of the input device, the one of the movement and the orientation of the input device being detected by the movement and orientation sensor;
orientation difference calculation means for calculating a difference between a predetermined reference orientation, and the orientation of the input device having been obtained by the movement and orientation information obtaining means; and
music performance means for executing music performance by producing a predetermined sound based on the difference in orientation calculated by the orientation difference calculation means.

19. A music performance system for executing music performance based on an input from an input device having a movement and orientation sensor for detecting one of a movement and an orientation of the input device itself, the music performance system comprising:
movement and orientation information obtaining means for obtaining information about one of a movement and an orientation of the input device, the one of the movement and the orientation of the input device being detected by the movement and orientation sensor;
orientation difference calculation means for calculating a difference between a predetermined reference orientation, and the orientation of the input device having been obtained by the movement and orientation information obtaining means; and
music performance means for executing music performance by producing a predetermined sound based on the difference in orientation calculated by the orientation difference calculation means.

20. A music performance method used by a music performance apparatus for executing music performance based on an input from an input device having a movement and orientation sensor for detecting one of a movement and an orientation of the input device itself, the music performance method comprising:
a movement and orientation information obtaining step of obtaining information about one of a movement and an orientation of the input device, the one of the movement and the orientation of the input device being detected by the movement and orientation sensor;
an orientation difference calculation step of calculating a difference between a predetermined reference orientation, and the orientation of the input device having been obtained by the movement and orientation information obtaining step; and
a music performance step of executing music performance by producing a predetermined sound based on the difference in orientation calculated by the orientation difference calculation step.
